(19) United States
(12) Patent Application Publication
(10) Pub. No.: US 2014/0222948 A1
(43) Pub. Date: Aug. 7, 2014

(54) SENDER-SIDE CONTENT TRANSMISSION METHOD AND INFORMATION TRANSMISSION SYSTEM

(71) Applicant: Takafumi Terasawa, Okayama-shi (JP)

(72) Inventor: Takafumi Terasawa, Okayama-shi (JP)

(21) Appl. No.: 14/343,333

(22) PCT Filed: Sep. 7, 2012
(86) PCT No.: PCT/JP2012/072979

§ 371 Date: Mar. 6, 2014

(30) Foreign Application Priority Data
Sep. 9, 2011 (JP) 2011-197588

(51) Int. Cl. H04L 29/08; G06Q 30/06

(52) U.S. Cl. CPC H04L 67/2842; H04L 67/1097; G06Q 30/0635
USPC 709/213; 709/217

(57) ABSTRACT

The user side is provided with a scanner and a transmitter, the T-center side is provided with a T-code decoder and a dispatch information generator, the user side transmits T-code-inserted image data, while the T-center generates order information (sender name, recipient name, sending method, address (recipient, sender), T-code-inserted image data, URL of supermarket, etc.) from the user, based on the decoding result of the image data, and the order information (simply dispatch information) is transmitted to supermarket via a communication network.

### TECHNICAL FIELD

The present invention relates to a method capable of sending information or items to a recipient without imposing a burden on the user.

### BACKGROUND ART

Today, with regard to the usage of the Internet, a method using an information terminal such as a computer or a mobile phone is the mainstream. However, communication using a computer is limited to a place where a computer is installed. In addition, communication via operation of a computer requires activation of an appropriate application.

This is because a computer is inherently assumed to be used for various purposes. Although services that take advantage of the Internet using a computer are very useful, they actually impose various constraints on the user in return for the convenience of exchanging information quickly.

Services that use existing information terminals impose the following constraints on the user, for example.

(Ordering Commercial Products Using a PC)

Today, in most cases where a user wants to compare a plurality of commercial products, the user prints the website of the content for comparison due to the limited screen size of the PC (Personal Computer).

The user then operates the keyboard to input, to the PC, the URL code of the product provider presented on the printed medium, receives an order screen, and inputs the desired product code, number of items, address information, telephone number, name, e-mail address, and the like on the order screen using the keyboard to place an order.

Alternatively, the user accesses the product provider site by reading the described QR code (registered trademark) or the like with a digital camera or the like.

More specifically, with the current method always provided with hardware (PC) linked to address information for accessing a company, destination information of the recipient (recipient address information) such as address, area, telephone number, e-mail address, or the like is added to the content information to be sent from the sender to the recipient using the hardware, and delivered to the recipient.

If the recipient who has received the information wants to return response information such as an order for a product, the current method adds destination information (sender address information) such as the sender's telephone number, FAX number, address, or the like, to the response information and transmits the information to the sender. Any type of communication method needs address information in addition to the content information and the response information.

In addition, there is an approach of placing an order with FAX. Placing an order with FAX also requires input of the destination FAX number.

In either case, placing an order with a PC or FAX requires the consumer i.e., the user to access the transmission destination by manual input.

In other words, the user is required to input various information as digital data, making it difficult for elderly people, or the like, who have difficulty with typing when communicating over the Internet. In addition, since the information entered in the PC includes personal information, there may also arise problems such as personal information leakage over the Internet.

On the other hand, communication using a printed medium such as a letter, flyer, direct mail can be read or written by anybody and seen anywhere, their presentation space being much larger than that of a display screen.

In addition, although a postal mail address is supposed to be associated with a person or a group using the information originally sent thereto, it is actually the address of physically existing land or building (i.e., hardware), and therefore postal mail requires entry of destination location.

On the other hand, although information of television or radio uses frequency information as the address, audio information is simultaneously delivered as the content.

In the case of a radio, for example, an announcer of a radio station must broadcast a URL http://www . . . , or a FAX number for sales promotion or obtaining answers from users to a questionnaire, and the user must make a note of it and separately operate a hardware device (PC, mobile phone, FAX, etc.) to input and transmit the information.

The following documents describe techniques to solve the above problems.

(Patent Literature 1)

Even if the website URL is known via newspaper advertisements or magazines, it has been difficult for a person who is not good at operating a PC to access the information.

In order to overcome the foregoing problem, Patent Literature 1 assigns a predetermined symbol to the URL of a company, a group or an individual who is a sponsor running an advertisement on paper media, television or radio, or who provides information that may become an article, and simultaneously displays a barcode expressing the predetermined symbol together with the URL.

A user who has seen an advertisement and wants to access the site connects to the site via a phone line, CATV, or ISDN.

The user then inputs the barcode described on the advertisement using a remote controller or a scanner, accesses the site, and receives provision of the website from the site.

In addition, an approach is also disclosed which stores a URL and a predetermined symbol string in association with a household appliance, and accesses the site of the URL when the symbol string is selected.

(Patent Literature 2)

Conventionally, products provided by product providers have been searched for on the WEB using URLs of advertising media such as newspapers, magazines, television, or the like.

For elderly people, however, input operation is troublesome. In order to solve the problem, Patent Literature 2 discloses a method of facilitating commercial transaction which allows a single-action transaction without any keyboard operation.

First, a 2-dimensional barcode corresponding to the product is preliminarily printed on newspapers, magazines, catalogs, or the like.

The 2-dimensional barcode is then read by an information device, address information of the user to be introduced is input by key-button operation, and the URL of the 2-dimensional barcode which has been read in is transmitted to the user. In this occasion, personal information stored in the information device is added and transmitted to the e-commerce server.

### CITATION LIST

### Patent Literature

Patent Literature 1: Japanese Patent Application Laid-Open Publication No. 2000-259527
Patent Literature 2: Japanese Patent Application Laid-Open Publication No. 2002-83232

### SUMMARY OF INVENTION

### Technical Problem

However, the conventional use of the Internet imposes various constraints on the user as described above.

In order to avoid imposing a burden on the user, on the other hand, the approach according to Patent Literature 1 reads a barcode described on an advertisement with a remote controller or a barcode reader, causes a computer to decode the information which has been read, accesses the site using the decoded data, and receives provision of the website from the site.

In addition, the approach stores a URL and a predetermined symbol string in association with a household appliance, and accesses a site of the URL when the symbol string is selected.

However, since the approach of Patent Literature 1 receives provision of the website of the site when a barcode is read in or a symbol string is selected, it is still necessary to operate the keyboard to search for a desired product and input personal information, or the like, again. In addition, even if input of personal information is not required, keyboard operation needs to be performed to order the desired product.

In addition, the approach according to Patent Literature 2 has a 2-dimensional barcode corresponding to the product preliminarily printed on newspapers, magazines, catalogs, or the like.

The 2-dimensional barcode is read using an information device, address information of the user to be introduced is input by key-button operation, and the URL of the 2-dimensional barcode which has been read in is transmitted to the user. In this occasion, personal information stored in the information device is added and transmitted to the e-commerce server.

In other words, according to Patent Literature 2, it is still necessary to operate an information device and input the address of the counterpart.

On the other hand, sales promotion or questionnaire on radio or the like also requires operation of a hardware device (PC, mobile phone, FAX or the like) for input and transmission.

Furthermore, although communication using printed medium such as a letter can be read and written by anybody and seen anywhere, their presentation space being much larger than that of a display screen, postal mail requires the destination name and the sender's address information. Using FAX also requires input of the destination number.

In other words, placing an order via a letter, advertisement, FAX, or the Internet imposes various constraints on the user as described above.

Furthermore, if the user wants to receive information from the sender by a letter, postcard or direct mail, or receive the product via door-to-door delivery by a company A, the user must notify his request beforehand.

For example, placing an order over the Internet requires input of how to receive the product, which is more troublesome.

It is therefore an object of the present invention, which is made in view of the problems described above, to provide a method by which a sender who wants to provide information to the user can easily transmit information desired by the user side to the address of the destination without imposing a burden on the user, and also the user can receive the information by a method desired by the user.

### Solution to Problem

One embodiment of the present invention is a sender side content transmission method which receives content directed to a recipient device from a sender device, determines, by a T-number attached to the content, a receiving method determined by the recipient, and transmits the content to the recipient device using a transmission tool which allows reception in accordance with the receiving method,

the method preparing:

a first storage unit configured to store the content;

a second storage unit configured to store, as T-number-inserted customer information, a unique code defined as the T-number for identifying the recipient, the receiving method of the recipient, the form of content to be received, the type of the content and the sender of the content, the T-number being associated with customer information including the recipient name, the device type used, and the device address, a code of receiving method, a code indicating the type of content to be received, and customer information including the sender name;

a third storage unit configured to generate therein recipient's receiving method definition information for transmitting the content to the recipient device; and

various transmission tools configured to connect the recipient device to a network and perform transmission and reception in a communication format thereof, and

the method causing a computer to execute the steps of:

(A1) receiving content from the sender device and storing the content in the first storage unit;

(A2) extracting the T-number from a T-code attached to the content, and storing the T-number in the third storage unit;

(A3) searching, from the second storage unit, the T-number-inserted customer information having the extracted T-number, and determining the recipient's receiving method included in the searched T-number-inserted customer information;

(A4) searching, from the customer information of the recipient included in the searched T-number-inserted customer information, the address of the recipient device capable of receiving by the determined receiving method;

(A5) reading a recipient name from the customer information of the recipient and a sender name from the customer information of the sender included in the searched T-number-inserted customer information;

(A6) generating, in the third storage unit, a set of the recipient device address, the recipient name and the sender name in association with the T-number as the recipient's receiving method definition information; and

(A7) activating the transmission tool which allows reception by the receiving method of the recipient's receiving method definition information generated in the third storage unit, and outputting the content to the transmission tool together with the address.

### Advantageous Effects of Invention

According to the present invention, as described above, a recipient can receive information from the sender side by a receiving method desired by the recipient without the sender side having to input the destination, the recipient, or the like.

### BRIEF DESCRIPTION OF DRAWINGS

FIG. 1 is an explanatory diagram illustrating a part of the outline of the present method of a T-center.

FIG. 2 is a schematic configuration diagram of a flyer-based information communication system of the present Example 1.

FIGS. 3(a) and 3(b) are explanatory diagrams illustrating a T-code label.

FIG. 4 is an explanatory diagram illustrating the concept of a T-code.

FIG. 5 is a detailed configuration diagram of the T-center.

FIGS. 6(a) to 6(c) are explanatory diagrams illustrating data in memories 36, 37 and 38.

FIG. 7 is an explanatory diagram of dispatch information.

FIG. 8 is a sequence diagram illustrating the operation of the present Example 1.

FIG. 9 is a sequence diagram illustrating the operation of the present Example 1.

FIG. 10 is an explanatory diagram illustrating a flyer with a T-code label attached thereto.

FIG. 11 is an explanatory diagram illustrating the flyer with a T-code label attached thereto.

FIG. 12 is a schematic configuration diagram of an information communication system of Example of Embodiment 4.

FIG. 13 is a schematic configuration diagram of a server system of the T-center.

FIGS. 14(a) to 14(c) are explanatory diagrams illustrating data in various memories of a database server 34.

FIG. 15 is an explanatory diagram illustrating a broadcast station transmission T-code.

FIG. 16 is an explanatory diagram illustrating sender transmission information and dispatch destination information.

FIG. 17 is a flow chart illustrating the operation of the sender terminal of Example 4.

FIG. 18 is a configuration diagram of a more specific communication system (information sending method determination method according to the recipient side).

FIG. 19 is a schematic configuration diagram of a server 300 of the T-center.

FIG. 20 is an explanatory diagram illustrating data of the T-code.

FIG. 21 is an explanatory diagram of T-number-inserted customer information Ji.

FIG. 22 is an explanatory diagram illustrating customer information.

FIG. 23 is an explanatory diagram of the T-number-inserted customer information of the T-center.

FIG. 24 is a sequence diagram illustrating the overall operation.

FIG. 25 is a sequence diagram illustrating the overall operation.

FIG. 26 is a sequence diagram illustrating the overall operation.

FIG. 27 is a sequence diagram illustrating the overall operation.

FIG. 28 is a sequence diagram illustrating the overall operation.

FIG. 29 is an explanatory diagram of recipient's receiving method definition information.

FIG. 30 is a schematic configuration diagram of more specific Example 2.

FIG. 31 is a schematic configuration diagram of a server 500 of the T-center.

FIG. 32 is a sequence diagram illustrating an operation.

FIG. 33 is a sequence diagram illustrating an operation.

FIG. 34 is a schematic configuration diagram of more specific Example.

FIG. 35 is a schematic configuration diagram of a server 800 of the T-center.

FIG. 36 is an explanatory diagram illustrating sending method T-number information.

FIG. 37 is an explanatory diagram illustrating recipient's receiving method definition information for group distribution.

FIG. 38 is an explanatory diagram illustrating an exemplary T-number registration screen.

FIG. 39 is an explanatory diagram illustrating an exemplary T-number registration screen.

### DESCRIPTION OF EMBODIMENTS

### Embodiment 1

In order to mitigate various burdens imposed on the user by service using existing information terminals, the present embodiment is a method of exchanging information between different communication systems without being constrained by the hardware address of each system.

In other words, the present method is one that allows dispatching certain information (content information) from a particular individual or the like (also referred to as sender in the following: the same goes for subsequent definitions) to a particular individual or the like (also referred to as recipient in the following) without imposing a burden on the user and without being constrained by the hardware address.

Generally, there are three requirements for exchanging information:

(1) information to be transmitted and received (content information, response information (reply to a test, input information for an inquiry or the like),

(2) sender address information, and

(3) recipient address information.

In contrast, the present method allows reception of information or items by a sending method based on a request of the sender or the recipient (e.g., whether the sender sends by door-to-door delivery, by postal mail, by e-mail, by FAX, or receives by URL access using a PC: whether the recipient receives by door-to-door delivery, by postal mail, by e-mail, by FAX, or receives by URL access using a PC), without having to input sender address information and recipient address information.

In other words, the present method aims at a method which does not require input of any address information by the sender or the recipient (also collectively referred to as the user) by including, in the content (e.g., image data of an image), a T-code by which address information of the sender or the recipient can be obtained.

In other words, the present method incorporates, in the content information, information (T-code) by which address information (to where and from where) can be associated with how it is dispatched, sorts the T-code at a T-center, i.e., the analysis center, and transmits it directly to the recipient.

In addition, the present method is one that exchanges information across different communication systems, and that concentrates all information in a single site (T-center), analyzes where and how to send the information, selects an optimal communication system (communication route) for the user to directly deliver the information to a desired site.

Existing transmission rules of information, devices, and addresses differ for each communication system, and therefore it is very difficult to provide a link in between. However, it is common for any communication system to send content information using a particular address rule.

The present method is one that adds, to the common content information, address information independent of address rules of individual communication systems, and transmits and receives address information together with content information.

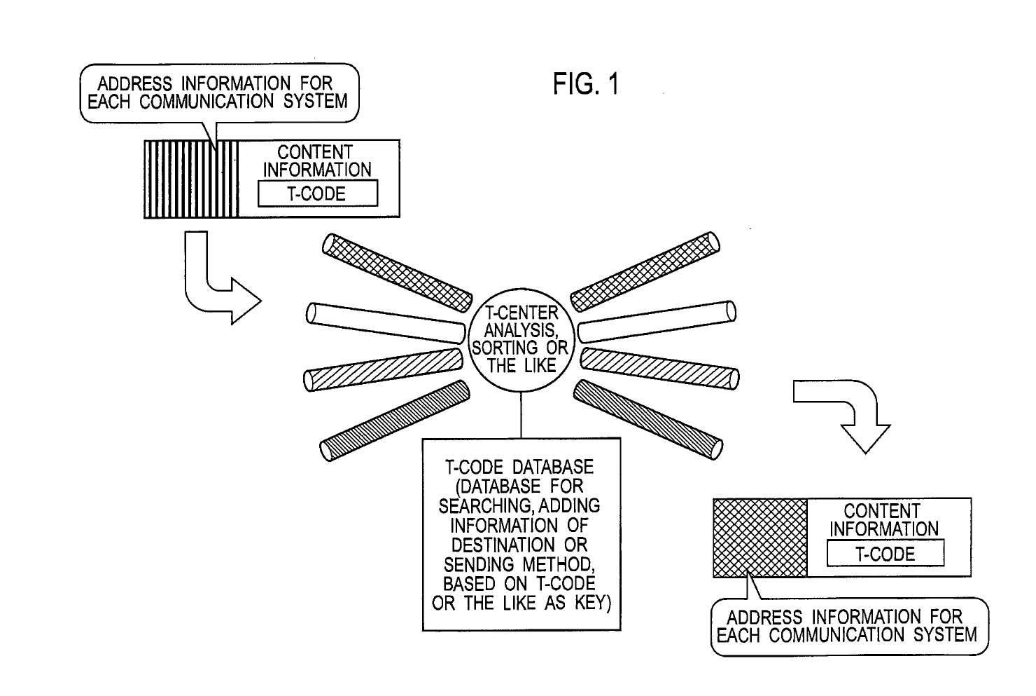

Thereby, exchanging information is facilitated beyond the limitation of already constructed communication systems. FIG. 1 illustrates the outline thereof.

More specifically, the present method is one that incorporates a T-code in the content to be transmitted by each of the media (the T-code and the content may be separated: the content and the T-code are transmitted and received in a manner linking the both) and transmits the T-code to a T-center (server) on the Internet, and that causes a server of the T-center, which has preliminarily encoded (referred to as T-code information) address information (to where and how) common to each medium (paper, audio, digital) into a form for each of the media, to analyze the T-code transmitted thereto, and dispatch the content to the address indicated by the T-code information corresponding to the T-code with a specified method.

The T-code information may include therein information for distinguishing between a sender, a recipient, and an intermediary, information indicating a transmission unit (type of communication system, language used for conversion, etc.), the destination address corresponding to each transmission unit, or the like.

In the present method, a T-code having, in addition to address information with regard to sending (sending method) from where (from whom) to where (to whom), information indicating how to send (referred to as T-code information: transmit information (sending method (receiving method)) may be incorporated in a paper medium at the sender side, or the present method uses a T-code having only a T-number (unique code) of several digits for identifying the T-code.

The T-number is not limited to a number of several digits, and may be anything such as an e-mail address, an ID of a scanner, a telephone number, or the like. In other words, there is also a method which treats, as a code usable for identifying who is the sender, an address of each user used in an existing communication system as a tentative T-number, which is used as a key to search a legitimate T-number and T-code information from a database.

Assuming such a rule to be a standard, exchange of information across different real media can be realized.

When the sending method (T-code information) is stored preliminarily at the T-center side in association with the T-number included in the T-code from the sender, the T-number is simply transmitted to the T-center as the T-code, and the sending method (T-code information) linked to the T-number is read at the T-center.

More specifically, the T-code (T-number) is printed as a QR code (registered trademark) on a content image to be read by a scanner, and transmitted to the T-center. The actual address information and T-code information are searched at the T-center using the T-number included in the T-code as a key, and the data is transmitted to the address according to the standard of the T-code information.

When the image data is supposed to be output to a printer, for example, it suffices to send the image data to the address specified by the T-code information, based on the searched T-code information (in this case, information instructing to add a rule that causes data conversion by the current printer driver, or to convert the information itself into an information form that can be directly processed by the printer).

In other words, driver information currently being recorded in the PC can be exchanged separately from the hardware. Since it is not realistic to write as much as the conversion information of the driver on a paper medium as a QR code (registered trademark), addition of information at the T-center in mid-course should be required when providing printer output. Accordingly, it is also possible to output scanner data from a printer without using a PC.

Inclusion of the above-mentioned sending method in the content of the sender allows the user to select a communication system such as e-mail, postal mail or FAX.

Current communication systems exchange information using address information (telephone number, address, etc.) assigned to the hardware of each communication system and do not have the concept of “recipient” or “selection”. Although exchange of information requires the address of the recipient, all the addresses of current communication systems correspond to hardware of the communication systems.

A sender-to-recipient communication is currently performed by a hardware-to-hardware communication, and actually far from a person-to-person communication. In other words, a code for use by a person is not assumed. In contrast, the present invention proposes assigning an ID (T-number corresponding to personal address information and combinations thereof, T-code combining them with T-code information indicating where and how: in the following, T-number and T-code are collectively referred to as T-code) to the concept of virtual recipient and sender, a combination thereof, and further a combination between the foregoing and a method of sending content (sending method).

The example of Embodiment 1 will be described below. The present example describes an example in which a person inexperienced in computers orders a product using a flyer.

### Outline of Example 1

With a current method which specifies address information using a hardware-specific IP address, it is necessary to reliably input address information at a terminal of the hardware. Accordingly, a function of reconfiguring the URL using an interface such as a keyboard or a printed QR code (registered trademark) is required at the terminal side. This is an obstacle for various people including elderly people when using the Internet.

In addition, even if a URL of a website is described on an advertisement, it is not effectively used due to difficulty of the input operation.

Making, by the present method, address information independent of the information terminal having an IP address assigned thereto allows digitized data to be delivered to any address without depending on the information terminal. One example thereof is preliminarily printing a T-code on a paper medium as a QR code (registered trademark), or incorporating a T-code in an image data file.

(Integration of Paper Media and the Internet)

As the most representative usage example, the enormous amount of newspaper flyers distributed by a company will be taken. Handbills have become a very versatile medium that can exhibit creativity without the need of a display. However, current flyers are very restrictive for bidirectional exchanges between the sender and the recipient.

In other words, although there exists a mechanism of printing a QR code (registered trademark) of the URL of the website of a company on a flyer and accessing it via a mobile phone, the recipient is required to be provided with hardware with an available IP address for accessing. In addition, despite that content information of a product or a service has reached the recipient as a paper sheet, it is necessary to provide a response (order, etc.) to the content information on the Internet, and also response information such as number of items must be entered in respective input forms.

It often happens that, a recipient who wants a certain product upon receiving a flyer or a catalog distributed from a supermarket can achieve his/her purpose by circling the photograph of the product, handwriting the number of items ordered, and sending the information to the company together with the recipient's personal address.

Currently, the exchange of such information depends on a mechanism such as postal mail or FAX, either of which requires address information (FAX number or address) of the sender of products and address information of the recipient (address or telephone number) to be attached.

In addition, when a company or the like performs a questionnaire and all that is required to reach the company is responses of individual recipients (when asking for comments on television or radio), it is necessary to use hardware such as a PC to enter address information such as FAX number of the company in order to aggregate the responses in a short time.

A specific example of the process flow will be described below. First, a company E widely distributes flyers having a T-code printed thereon. An individual P who has seen the flyer handwrites on the flyer his address and an order of a service he wants, converts all or a part of the flyer including the T-code into image data with a camera of a scanner or a mobile phone or with a digital camera, and further transmits the image to a particular switching system (T-center). The T-center which has received the image data identifies and analyzes the T-code included in the image, and transfers the image to the recipient's e-mail address or the like obtained as a result. Here, the individual need not input the address of the company, and need not be an owner of a terminal used for transmission. In addition, it is not necessary to input or select the e-mail address of the transmission destination or the IP address of the server with a scanner or a digital camera, and data may be delivered by simply preparing a button having a function of uploading data to a particular IP address, thus simplifying the communication device.

### Example 1

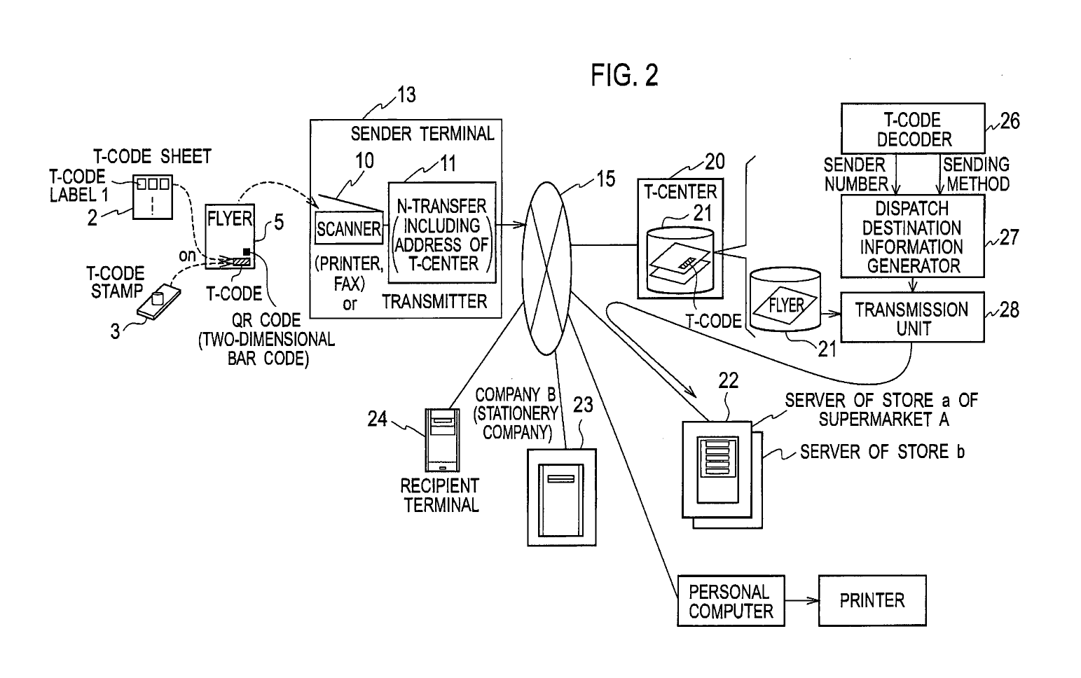

FIG. 2 is a schematic configuration diagram of a flyer-based information communication system of the present Example 1.

The present Embodiment 1 describes an example in which a parent, who is inexperienced in an information communication terminal and has seen a flyer distributed from a supermarket A, sends a product on the flyer to a child living far away.

In addition, a sheet 2 having a T-code label 1 attached thereto or a T-code stamp 3 described below has been preliminarily dispatched to the user from the T-center.

In addition, since the sender is inexperienced in information terminals such as a PC or a mobile phone, it is assumed that the person in charge of the T-center has preliminarily asked the sender about the name, address, telephone number, FAX number of the sender, as well as to whom the item is to be sent (the sender may be the recipient), how the sender wants to have the product of the product provider delivered, or the like, has generated the T-code label 1, and has passed T-code seals as described above to the sender (any number of seals are allowed).

For example, it is assumed that the T-code label 1 has printed thereon a 2-dimensional barcode (QR code (registered trademark)) indicating a set of a T-number (e.g., a code of about 12 digits including a numerical string and symbols) and a code (e.g., TCODE) for identifying a T-code. The T-number may be an e-mail address.

The T-number is a code for distinguishing between the sender and the recipient, and IP addresses of the sender and the recipient, address information such as the dispatch destination address, and the specified sending method can be decoded at the T-center using information linked to the T-number and the T-code. It is not necessarily required to describe both the T-number and the sending method in the T-code, and a number associated with the combination of the T-number corresponding to the sender and the recipient, and the sending method may be written as the T-code.

A T-number registered in the server of the T-center, which is also referred to as recipient side receiving method definition information Jhi, includes the T-number, the sender side name (which may also be the sender customer code), the recipient name (recipient side customer code), the recipient's receiving method (receiving by e-mail attachment, receiving by postal mail, receiving by printer output, etc.), or the like.

In addition, it is assumed that a flyer 5 from the supermarket A is handed to a user (a person who is inexperienced in a PC), in a manner inserted in a newspaper. It is assumed that the flyer 5 has described thereon a URL code of the supermarket A, or a QR code (registered trademark) including the address of the website of the supermarket A and the serial number of the flyer, or a FAX number. The present embodiment assumes a flyer having a T-code described in the form of a QR code (registered trademark).

As illustrated in FIG. 2, an information communication system of the present Example 1 of the present Embodiment 1 has the following components at the user side.

(User Side)

There are provided a scanner 10 (a color scanner is desirable) having a USB terminal, a transmission button, a start-reading button, and a transmitter 11 having a USB terminal, which imports image data from the scanner 10 and transmits it to a preliminarily prepared T-center.

The transmitter 11 (N transfer: registered trademark) has stored in a memory thereof (not illustrated), the IP address of its own and the IP address (URL) of the T-center.

Pressing the transmission button causes the aforementioned scanner 10 to send, to the transmitter 11, image data having attached thereto a T-code label (URL, name etc. of supermarket A, T-number and sending method are written as a QR code (registered trademark)) of the flyer which has been read in.

On the other hand, the transmitter 11 receives the image data of the flyer 1 from the scanner 11, adds the IP address of its own and the IP address (URL) of the T-center to the image data, and transmits the data (referred to as transmission information Ui in the following) to a communication network 15.

The transmission information Ui from the user is transmitted to the T-center.

(T-Center)

On the other hand, the T-center has, as illustrated in FIG. 2, a memory 21 which stores transmission information from the user, and a T-code decoder 26 which extracts the image data of the T-code label 1 of the T-code-inserted image data stored in the memory 21, and decodes the T-code in the T-code-inserted label.

In addition, there is also provided a dispatch information generator 27. The dispatch information generator 27 generates order information from the user (sender name, recipient name, sending method, address (recipient, sender), T-code-inserted image data, URL of supermarket A and the like), based on the result of decoding. Since there may be a case where the user has entered, in the image data, information of the sender such as address, telephone number, name, or the like, the sender name may be left blank.

In addition, there is also provided a transmission unit 28. The transmission unit 28 transmits order information (simply referred to as dispatch information Ji, too) via the communication network 15.

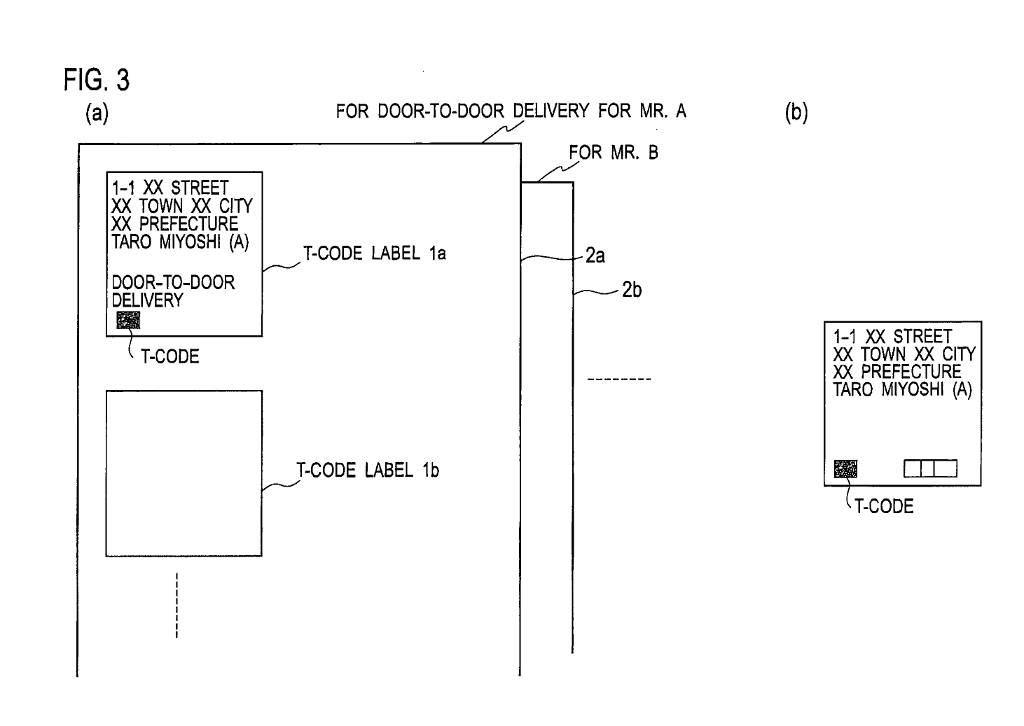

Next, a T-code label will be described using FIGS. 3(a) and 3(b).

As illustrated in FIG. 3(a), the surface of the T-code label 1 (1a, 1b, . . . , the size being about 2 cm wide and long, or about 3 cm wide and 2 cm long) has, for example, address, name, sending method (e.g., door-to-door delivery), and T-number described thereon, with the back side thereof having paste applied thereto, and a large number of the T-code labels 1 are attached to a sheet (the sheet are referred to as a T-code sheet 2).

In addition, the address, name, and sending method of the sender are described on the label by characters for facilitating user understanding. However, the address, name, and sending method need not be printed thereon if the user makes it clear (e.g., by different colors), or if it is clear to the user how and to whom an item is supposed to be sent.

One sheet may be used as a T-code sheet for a child living far away, and other sheets as T-code sheets for friends (2a, 2b, . . . ) and for the user him/herself.

It is preferred that the T-code sheets 2i are preliminarily notified to the T-center and distributed to the user.

For example, the address, name, telephone number, and FAX number of the sender, and the address, name, telephone number, FAX number, e-mail address, and further, credit card information, or the like of the recipient are preliminarily notified and delivered (membership).

In addition, the T-code label 1 may be provided with an input column as illustrated in FIG. 3(b). This is for eliminating preliminary registration of a sending method in the T-center, for example, and, in the case of a four-digit numerical entry, codes such as 1001 for door-to-door delivery, 0022 for postal mail, 3000 for home delivery, and 4000 for catalog request may be preliminarily determined. Accordingly, the sending method can be specified by simply writing numbers, thereby allowing the sender to specify sending by door-to-door delivery this month, or requesting a catalog by e-mail next month.

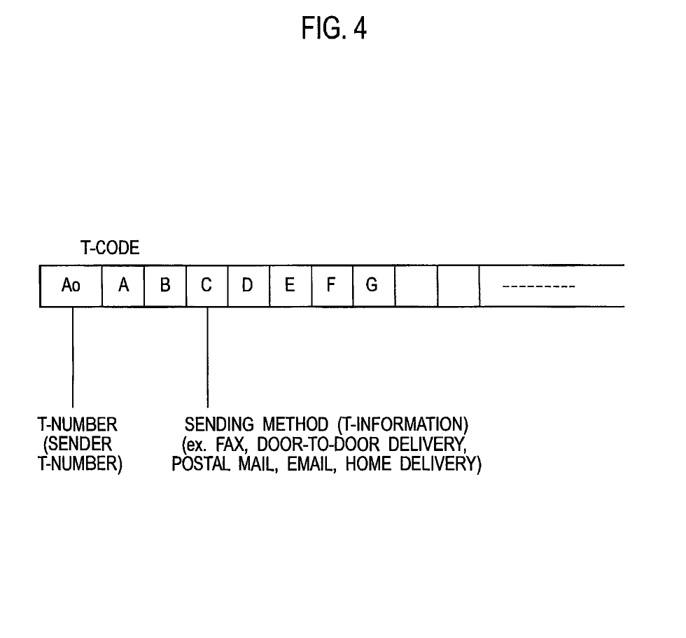

FIG. 4 is an explanatory diagram illustrating a T-code of a T-code label not having a numerical input column. The T-code may be a 2-dimensional barcode such as a QR code (registered trademark) or a 1-dimensional barcode, and when information A0, A, B, C, . . . is provided, as illustrated in FIG. 4, A0 is associated with the T-number and C with the sending method (FAX, door-to-door delivery, postal mail, e-mail, home delivery, . . . : T-information). The code C indicating the sending method includes C1 as the code for door-to-door delivery, C2 as the code for e-mail, and C3 as the code for postal mail, with address information corresponding thereto being expressed in different slots.

In addition, the T-number of A0 is a number for identifying the T-code printed on the T-code label. If the sending method and the address are held in the T-center, only the T-number will do.

In addition, B of these T-codes may be used as a code indicating that they are T-codes.

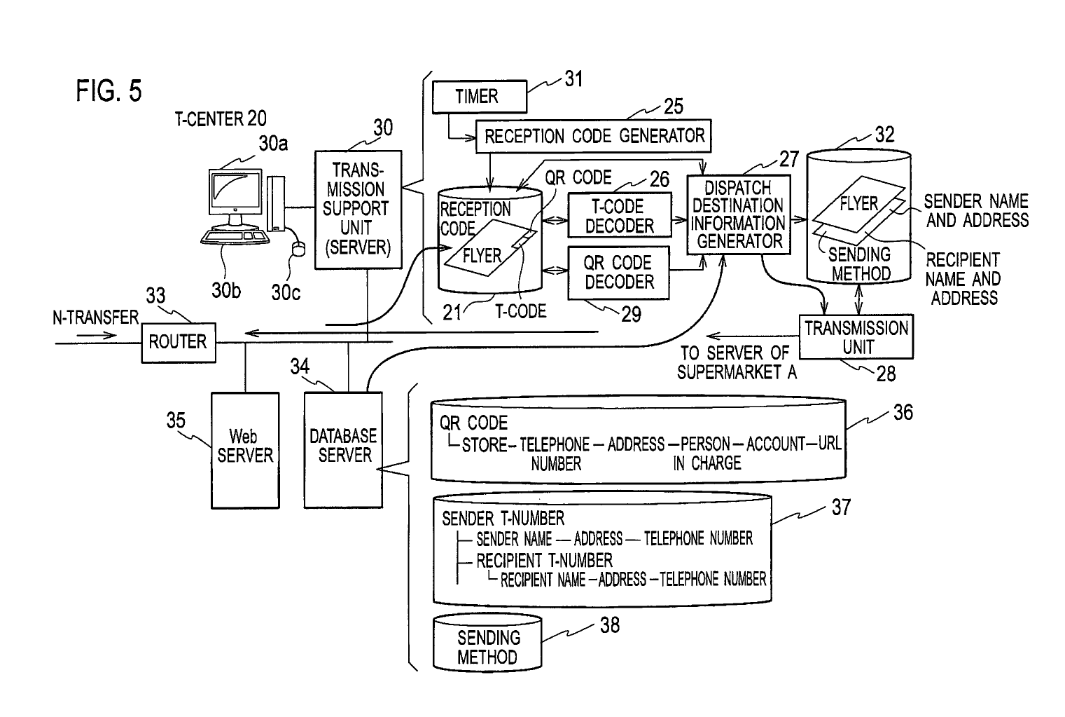

FIG. 5 illustrates a specific configuration of the T-center. The T-center is provided with a router 33, a Web server 35, a database server 34, a transmission support unit 30, and the like (also referred to as computer main body), as illustrated in FIG. 5. The transmission support unit 30 has connected thereto a display unit 30a, a keyboard 30b, a mouse 30c, and the like.

The database server 34 includes a memory 36, a memory 37, a memory 38, and the like.

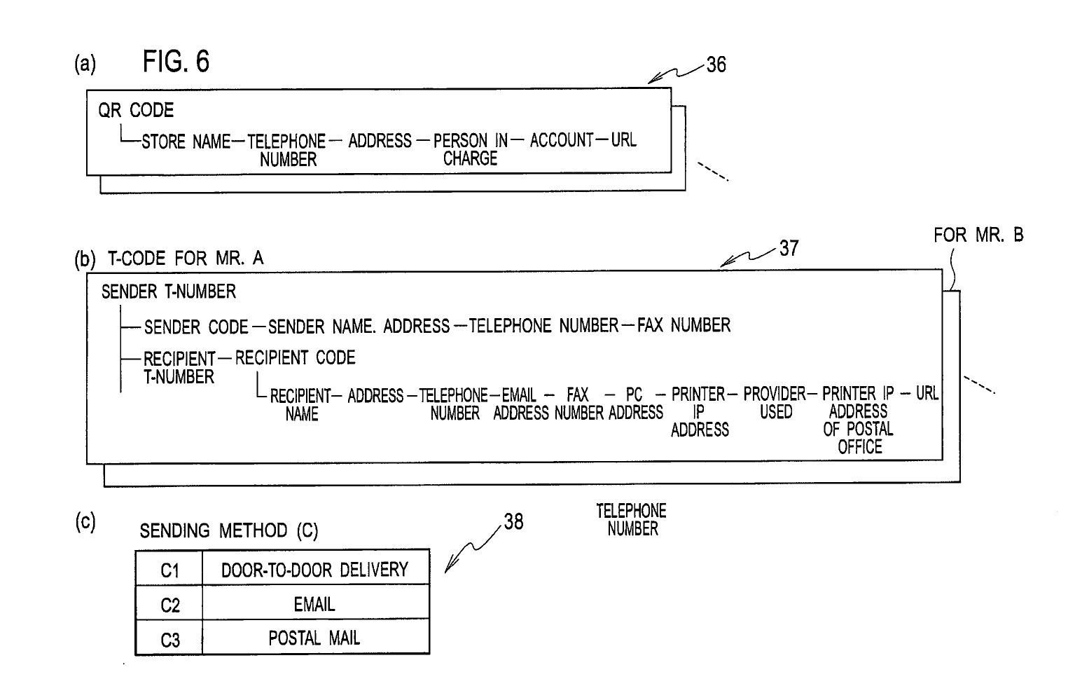

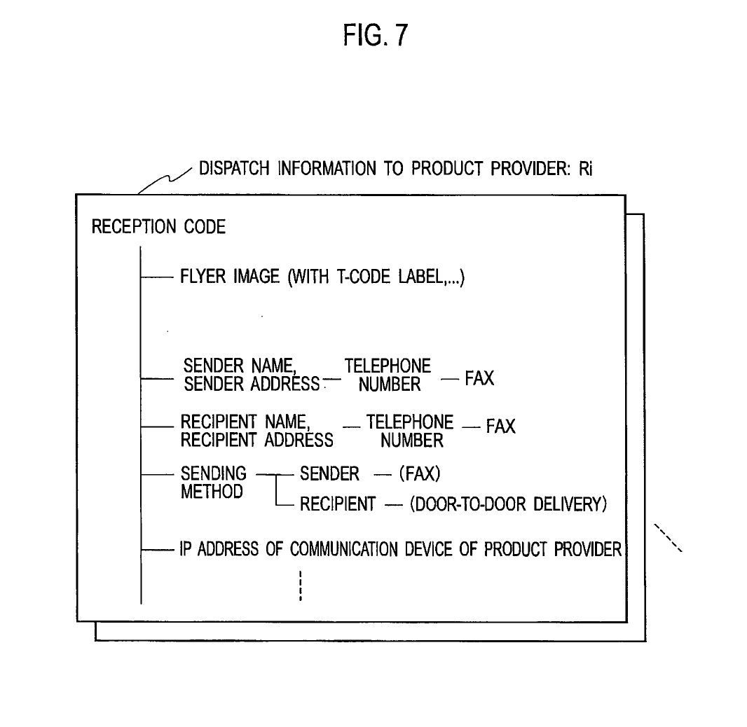

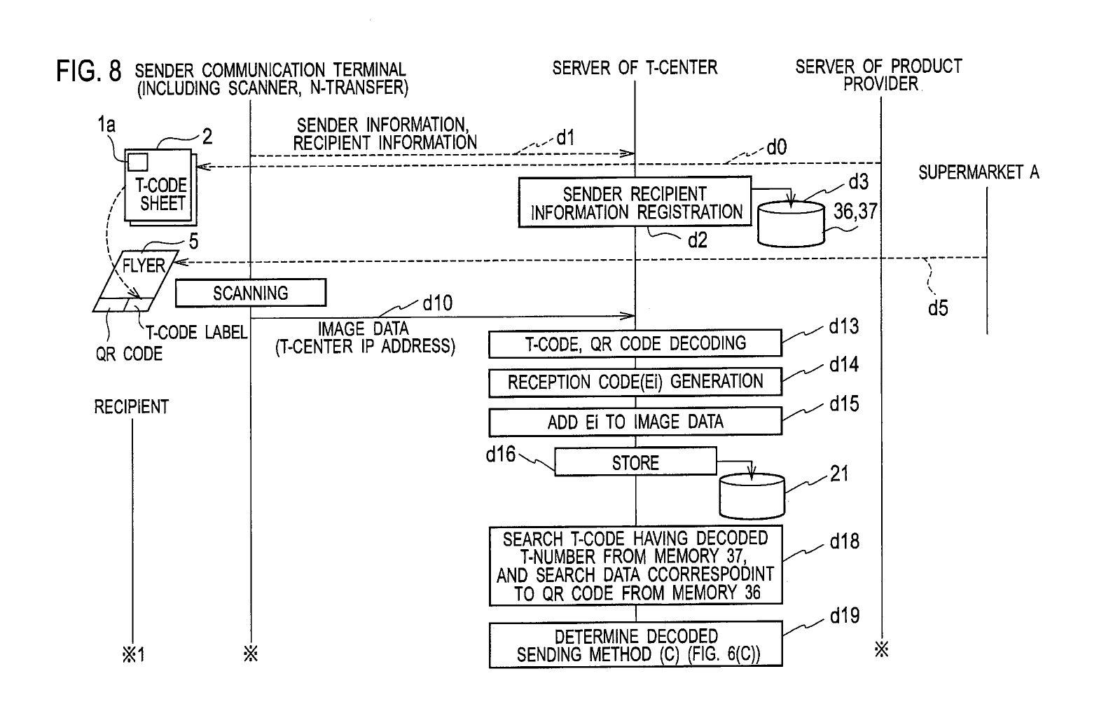

As illustrated in FIG. 6(a), the memory 36 stores the store name (supermarket A), telephone number, address, name of person in charge, account number, URL code, and the like of the product provider in association with each other in a numerical sequence corresponding to a QR code (registered trademark).

In addition, the memory 37 stores the T-number for each sender (for Mr. A, for Mr. B, . . . ), as illustrated in FIG. 6(b).

The T-number for the sender (also referred to as sender T-number) is stored in association with the sender name, address, telephone number, FAX number, and the like.

Furthermore, the sender T-number is linked to T-numbers of a plurality of recipients (also referred to as recipient T-numbers). The recipient T-number stores the recipient name, address, telephone number, e-mail address, FAX number, and the like in association with each other.

In addition, the memory 38 has the code C (C1, C2, . . . ) of the sending method associated with an actual sending method, as illustrated in FIG. 6(c). For example, the code C is stored such that C1 is for door-to-door delivery, C2 for e-mail, C3 for postal mail, . . . .

In other words, if the sender, for example, selects a T-code label of a child living far away which has been preliminarily dispatched from the T-center, pastes the T-code label on a flyer, and reads in the T-code label with a scanner, the recipient T-number of the child living far away which is linked to the sender T-number is searched in the memory 37, and the address, name, e-mail address, and the like, linked to the recipient T-number are extracted therefrom. If the sending method to the child is door-to-door delivery (C1), an item is supposed to be dispatched by door-to-door delivery.

On the other hand, the transmission support unit 30 includes a timer 31, a reception code generator 25, a T-code decoder 26, a QR code (registered trademark) decoder 29, the transmission unit 28, the memory 21, a memory 32, and the like.

The memory 32 stores order information Ji for the product provider illustrated in FIG. 7.

(Description of Operation)

An operation of the transmission system configured as described above will be explained below. In the present Example 1, a case where a parent living in one prefecture dispatches a product of the supermarket A to a child living in another prefecture is taken as an example.

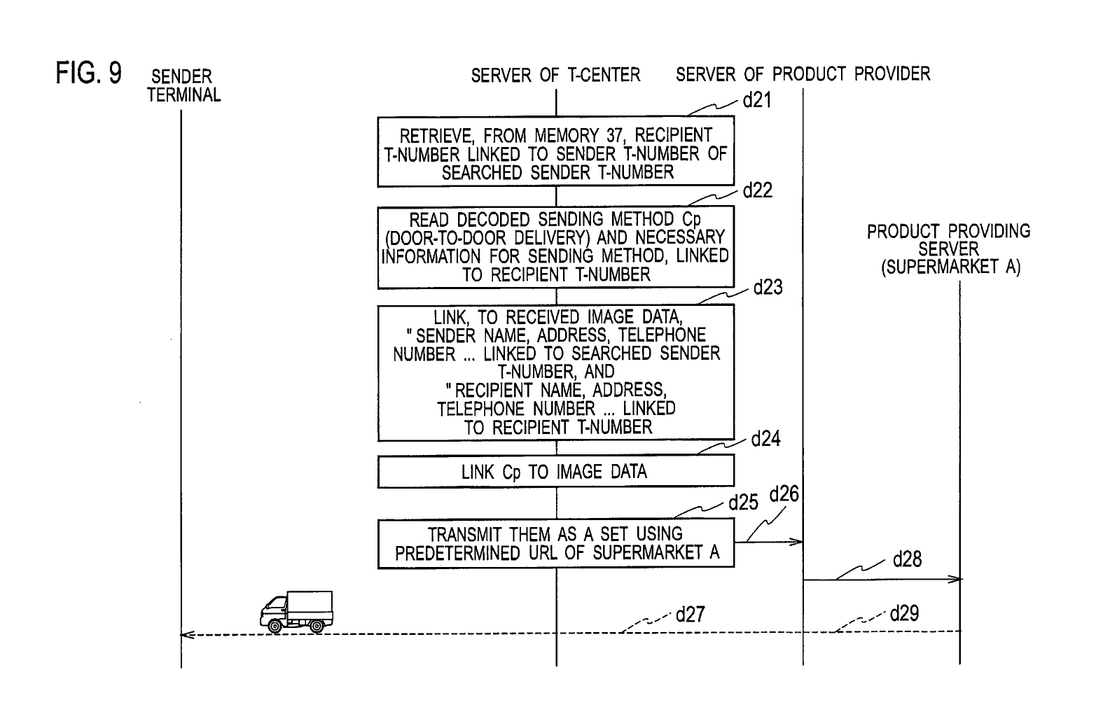

FIGS. 8 and 9 are sequence diagrams illustrating the operation of the present Example 1.

Since the sender in the present Example 1 is inexperienced in information terminals such as a PC or a mobile phone, the person in charge of the T-center preliminarily asks and gets the sender the name, address, telephone number, and FAX number of the sender, as well as to whom the item is supposed to be sent (the sender himself may be the recipient) and how the sender wants to have a product of the product provider delivered, generates one or more T-code seals described above (any number of seals allowed), and preliminarily delivers them to the sender (d0).

The person in charge of the T-center then operates the computer to register the personal information (recipient information, sender information), which was preliminarily asked and got, in the memories 36 and 37 (d1, d2, d3).

In addition, it is assumed that the supermarket A has preliminarily delivered a flyer of a special bargain day to the user (sender) in the form of an inserted flyer (d5).

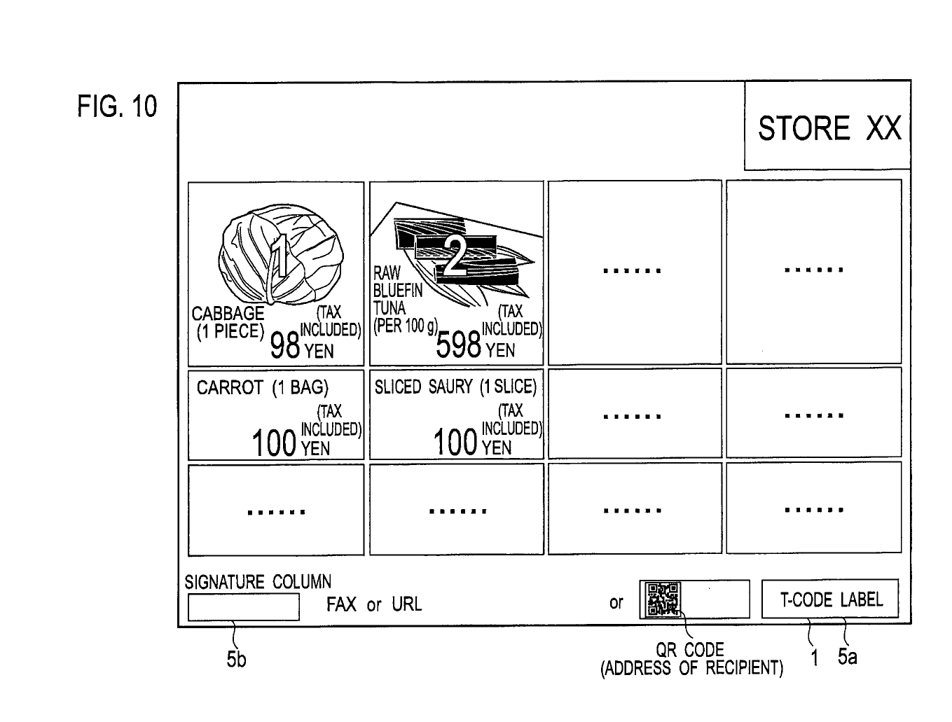

The sender then reads in the flyer 5 and, as illustrated in FIG. 10 for example, writes the number of items in the column of the desired product (e.g., the number indicated by outline character), and pastes the T-code label for the child living far away on the T-code label pasting column 5a, and also handwrites his signature in the signature column. The signature, which is sent to a card company as image data as necessary, may be compared with a credit card number, or the like associated with the T-code and can be used for settlement.

The flyer 5 is provided with a T-code label column 5a and a signature column 5b, and also has a QR code (registered trademark) indicating the URL of the supermarket A, publication number, date and the like, and FAX number.

Next, the sender reads in the flyer 5 with the scanner 10 and presses the transmission button to cause the transmitter 11 to send the T-code-label-inserted image data of the flyer which has been read in, and the transmitter 11 receives the image data of the flyer 5 from the scanner 10, adds the IP address of its own and the IP address of the T-center (referred to as transmission information from the user) to the image data, and transmits the information to the communication network 15 (d10).

The transmission information Ui from the user has its IP address decoded and is transmitted to the T-center.

On the other hand, the T-center retrieves the transmission information Ui from the user using the router 33 and the web server 35, and outputs it to the transmission support unit 30.

The transmission support unit 30 stores the transmission information Ui in the memory 21, the T-code decoder 26 extracts a region of the T-code label and converts the 2-dimensional barcode of the T-code label into a numerical sequence to decode the T-code, and the QR code (registered trademark) decoder 29 extracts a region of the QR code (registered trademark) and converts the QR code (registered trademark) into a numerical sequence to decode it (d13).

In other words, an image format of the flyer of the special bargain day from the supermarket A has been preliminarily dispatched to a memory (not illustrated) of the database 34, and the transmission support unit 30 reads coordinates on the flyer indicating the T-code label region and the region of the QR code (registered trademark) of the image format to extract the T-code label region and the QR code (registered trademark) region of the flyer of the image data of the transmission information Ui.

Decoding by the aforementioned T-code decoder 26 is meant to decoding what the T-code (see FIG. 4) indicates. For example, the T-number of the T-code label (A0: corresponding to the sender T-number), the sender code (A), the sending method (C) are decoded.

On the other hand, the reception code generator 25 reads current time point ti (year-month-day, hour, minute, second) of the timer 31 upon receiving the transmission information Ui, generates a reception code Ei (unique code) of several digits based on the current time point ti, and stores the reception code Ei in the memory 32 in a manner linked to the image data of the memory 21 (d14 to d16).

The dispatch destination information generator 27 illustrated in FIG. 2 then searches, in the memory 37, a T-code having the T-number (A0) decoded in the T-code decoder 26, and searches, in the memory 36, the numerical sequence of the QR code (registered trademark) corresponding to the decoded QR code (registered trademark) (d18).

Next, the dispatch destination information generator 27 determines what the decoded sending method (C) is, referring to the memory 38 (see FIG. 6(c)) (d19).

Next, the dispatch destination information generator 27 retrieves, from the memory 37, the recipient T-number linked to the sender T-number of the searched T-code, as illustrated in FIG. 9 (see FIG. 6(b)) (d21).

The dispatch destination information generator 27 then reads the determined sending method and the name, address, telephone number, or the like linked to the recipient T-number and the sender T-number (d22). In the present embodiment, Cp indicates door-to-door delivery. In the case of the T-code label provided with a check input column illustrated in FIG. 3(b), the dispatch destination information generator 27 decodes the pattern of the check input column by an OCR function to determine, from the memory 38, whether the sending method is door-to-door delivery, postal mail, or the like, and defines it as the sending method Cp.

When e-mail is included in the sending method in addition to door-to-door delivery, the e-mail address linked to the recipient T-number may be attached to Cp. In this manner, it becomes possible to provide preliminary notification by e-mail that door-to-door delivery will be made from the sender to the recipient.

Next, the name, address, telephone number . . . of the sender linked to the searched sender T-number, and the name, address, telephone number . . . of the recipient linked to the recipient T-number are linked to the image data of the memory 32 (d23).

Next, the determined sending method Cp (door-to-door delivery) is linked to the image data of the memory 32 and the transmission unit 28 is activated (d24).

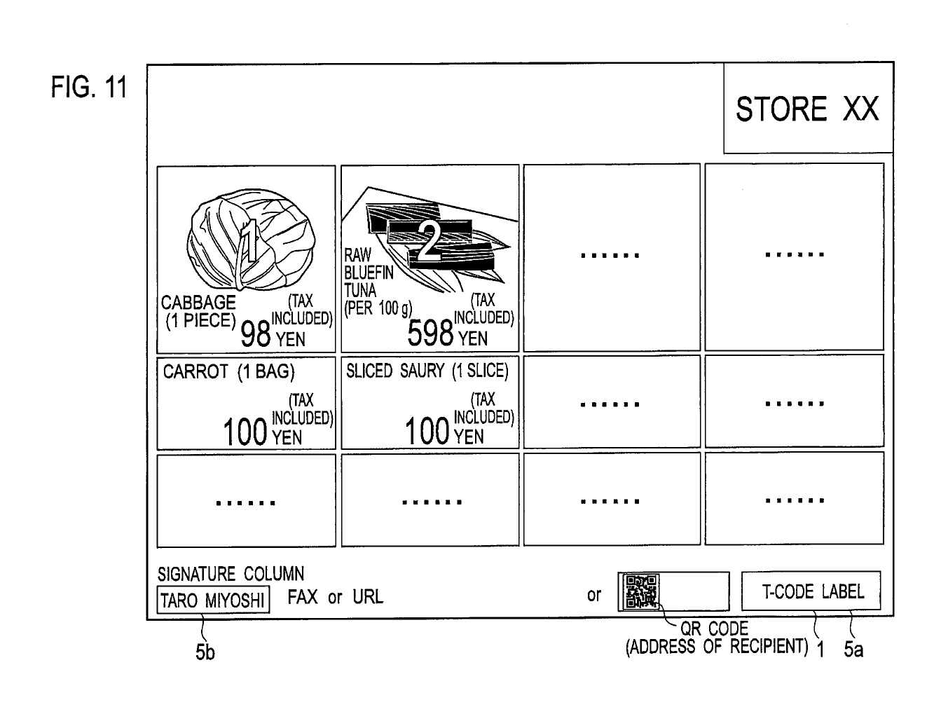

The transmission unit 28 transmits the image data of the memory 32, Cp, the name, address, telephone number, . . . of the recipient, and the name, address, telephone number, . . . of the sender, using the URL code of the supermarket A (d25, d26). In other words, the image data as illustrated in FIG. 11 is automatically dispatched to the supermarket A. That is, since the T-center has stored therein the sender T-number linked to the recipient T-number, the sender does not have to attach the T-code for identifying the recipient each time.

The person in charge of the supermarket A, referring to the received image data, instructs a predetermined door-to-door delivery company to deliver the specified product to the recipient (a child living far away) (d28, d29).

Therefore, when the user who is the sender wants to send a product of the supermarket A to a child, the user can have the product delivered to the child living in a certain prefecture by simply writing the number of items directly in the product column of the flyer distributed one week before the special bargain day, reading in the flyer with a scanner, and pressing the transmission button. In other words, there is no trouble with the user even if the user is not familiar with an information terminal.

Although the foregoing explanation has described sending a product listed in a flyer of the supermarket A by door-to-door delivery, the process for a case where the product provider is an insurance, securities, bank, or education company goes like the following: if the company has dispatched to the user an advertisement having described thereon a choice between requesting or not requesting a catalog, with a T-code label indicating that the sending method is postal mail (the recipient being the company name and the sender being the user) enclosed, when the user pastes the T-code label on the application form of the catalog request, reads in and transmits, to the T-center, the application form with a scanner, the T-center transmits the image data from the scanner to the company.

In the above manner, the company, knowing that the sending method is described as postal mail, can dispatch a catalog to the user by postal mail.

In addition, by simply providing, to a digital camera without a communication function, a function of inserting a T-code image in photograph data (image) or adding the T-code image on a separate frame, it is possible to transmit image data to a specified address by a particular method by connecting the camera to a communication terminal provided with a function of transmitting image data to a particular T-center, and uploading the image data.

In other words, the present method allows the sender to send data to a particular address of the recipient (corresponding to whom) corresponding to a particular communication system in a particular form (corresponding to how), by simply recording a particular ID (T-number) or the like in the content without being aware of the address of the recipient (information about to where, and how an item is sent) corresponding to a communication system (the sender does not have to record anything if the ID has been preliminarily recorded). For example, by preliminarily assigning a T-number to a visually impaired recipient, registering a mobile telephone number as the communication system thereof, and further reading aloud a text of the image file which has been sent thereto as a conversion rule of information (corresponding to how to send an item), and specifying a rule for converting it as audio information, for example, it becomes possible to deliver sound of an audio file to the mobile phone of the visually impaired recipient directly from the T-center by adding, by a hearing impaired sender, a T-code having the T-number of the visually impaired recipient recorded on a letter written on paper and transmitting it to the T-center.

Moreover, if there is an individual who wants to receive a service anonymously, after the recipient (individual) T-code is transmitted as image data to the company which is the sender of the service, the product from the company is delivered to the delivery center or the T-center with the recipient T-code attached thereto, the company sends the delivery request and the T-code of the product to the T-center, the T-center having received them distributes a correspondence database of the personal T-code and the address to the delivery center, and the delivery center, after checking it, delivers the product with the address attached thereto, and thus it becomes possible for the individual to receive a product or service without disclosing personal information such as his address to the company.

In addition, there is also a somewhat simpler and easier service (referred to as URL distribution service) using the switching system described above. In recent years, most companies have a website established on the Internet and its URL disclosed to individuals by advertisements, prompting access thereto.

However, although a website which has been visited once can be easily accessed thereafter if its URL is recorded in an information terminal, the initial access thereto always requires input of the URL to the terminal. Today, although access from mobile phones has become easy using QR codes (registered trademark) or the like, a reading sensor is required at the terminal and, in most cases, websites are arranged for mobile phones provided with a reading sensor, which requires the user to transfer the URL by himself to visit the websites with a PC or the like.

Here, if a personal mobile phone e-mail address and a PC address are recorded in a distinguished manner in the recipient (individual or the like) T-code to be processed at the T-center, and also URLs for a PC and a mobile phone are respectively prepared in the sender (company or the like) T-code, it is possible to distribute the URL to either the PC or the mobile phone as appropriate, or to the both.

### Embodiment 2

A variety of services using T-codes may be envisaged, with the category of information used being different for each service (in the example of the URL delivery service, recipient mobile phone e-mail, recipient PC e-mail, company mobile phone URL, company PC URL, etc.).

A variety of services may be envisaged such as the aforementioned delivery service of image data to a credit company, a service undertaking questionnaire investigation, and the like, with the category of information (referred to as T-code attribute) used being different for each service. Although there is also a method of incorporating all the information in the T-code separately for each service, various services are expected to emerge in the future. Accordingly, distinction of information to be used in each service (referred to as T-code attribute) is separately defined and, further incorporating in a T-code an ID specifying which attribute the service is supposed to use (service category ID) makes it possible to prepare, at the T-center which received it, a mechanism of sending information to both the sender and the recipient, while limiting the information to information of the T-code attribute corresponding to the service category ID.

If an individual does not want to transfer his address information to a company, there is needed a distinction of services so as to prevent the address information from being delivered to the company. Although the user may prepare a recipient T-code including only information by which an individual cannot be identified, and a recipient T-code including information by which an individual can be identified, the distinction may be guaranteed by the T-center (mechanism of guaranteeing security).

In other words, the company is obligated to put authentication (logo or the like) of the T-center in the vicinity of the company T-code, and display a symbol or explanation indicating the level of handling personal information (QR code (registered trademark)) in the authentication. There is also a method in which, for example, numeral 1 indicates inclusion of only anonymous information such as an e-mail address or a nickname, whereas numeral 2 includes information that allows identifying an individual such as name or telephone number, which are printed in the vicinity of the T-code, and the T-center assures to which level the user is supposed to treat personal information.

Strictly speaking, it is also necessary to prepare a QR code (registered trademark) indicating the handling method and actually check, at the T-center, whether or not it matches with the security level attribute described in the T-code of the company.

The information to be incorporated in the T-code has, for example, the following attribute (inside the parenthesis is an example of the information). These pieces of information may be added and sent as another attached information without being incorporated in the content itself (it is needless to say that an appropriate rule is required).

The following is exemplary attribute information (several keys that can be changed by a combination of expiration date, company, and service) indicating a T-code.

messenger attribute (distinction between sender, recipient, intermediary or the like),

address attribute (distinction between e-mail, ftp, postal mail, FAX, telephone, T-number, name or the like), address content (e-mail address, number, and real name corresponding to each attribute),

service category attribute (service category ID),

service attribute (service ID: to be used for which service),

security attribute (level of personal information such as anonymous, real name or the like),

business form ID (business form ID to be used for checking in OCR and OMR processing),

conversion attribute (whether or not to perform data conversion),

conversion method attribute (in what type of form data conversion is performed),

conversion tool attribute (specifying an application or the like which performs data conversion).

If the T-center stores, in association with the T-number, an address attribute (distinction between e-mail, ftp, postal mail, FAX, telephone, T-number, name or the like), address content (e-mail address, number, and real name corresponding to each attribute), a service category attribute (service category ID), a service attribute (service ID: to be used for which service), a security attribute (level of personal information such as anonymous, real name or the like), a business form ID (business form ID to be used for checking in OCR and OMR processing), a conversion attribute (whether or not to perform data conversion), a conversion method attribute (in what type of form data conversion is performed), a conversion tool attribute (specifying an application or the like which performs data conversion), the T-code from the sender is assumed to be attribute information indicating a T-code (several keys that can be changed by a combination of expiration date, company, and service) and a messenger attribute (distinction between sender, recipient, intermediary or the like: T-number).

Registering a security attribute for each service category ID and preparing it as a database allow versatile control of the type of address information to be output, such as making the security attribute unnecessary, by defining the relationship between attributes. Additionally, in the case where an IP address is assigned to individual digital camera, scanner, or printer in the future, it will also become possible to output, by a printer without using a PC of an individual, information which has been converted into an image by a scanner, for example, by registering a conversion rule for outputting, on a certain type of printer device, image data which has been sent thereto, applying the rule, and delivering the information as is to the address of the specified printer.

As for a T-code, there may be prepared QR codes (registered trademark) different for each of the sender and the recipient, or a single QR code (registered trademark) may incorporate T-code information of both parties. For example, if information such as the address of the individual has already been registered and an ID has been assigned thereto when a certain company dispatches a catalog to a certain individual, it is also possible to print in a T-code both the identification number of the individual incorporated as the T-number, and the e-mail address of the company as the recipient address, on a direct mail such as a catalog, and to distribute the direct mail (two types of T-codes may be printed which distinguish between the sender T-code and the recipient T-code, respectively).

In other words, if the company has grasped address information assuming an individual to be the recipient and assigned an ID thereto, it is possible to preliminarily print the ID of the individual in the T-code in a variable manner and send it to the individual by postal mail or the like. In other words, it is not necessarily required to install a database associating a T-number with address information at the T-center, by recording a number which functions similarly to the T-number recorded in the T-code (number associated with address information: broadly referred to as T-number) in a T-code as address information, and performing analysis thereof at the company.

### Embodiment 3

In addition, the recipient may preliminarily register, in the T-center, by which method, i.e., e-mail, FAX, or postal mail, the recipient wants an item to be delivered, whereby the sender has to know only the ID (the T-number) corresponding to an individual and does not have to know the sending method.

A specific example of the process flow will be described below. First, a company E widely distributes flyers having a T-code printed thereon (the T-code in this case is the URL or the T-number of the company E). An individual P who has seen the flyer handwrites on the flyer his address and an order of a service he wants, converts all or a part of the flyer into image data with a scanner, a camera of a mobile phone or the like, and further transmits the image to a particular switching system (server system of the T-center). The switching system which has received the image data identifies and analyzes the T-code included in the image, and transfers the image to the recipient's e-mail address or the like obtained as a result.

For example, each recipient P preliminarily stores in the T-center the T-number in a manner linked to the address, name, e-mail address, FAX number, sending method, or the like, and also stores the T-number of each recipient P in a manner linked to the T-number of the company E. If, alternatively, the T-number of each recipient P is stored in the T-center without the T-number of each recipient P being linked to the T-number of the company E and, when the sender dispatches image data to the recipient P, the T-code included in the image data is read, and the T-number of each recipient which has been preliminarily stored is linked to the company E included in the T-code.

In the above manner, the switching system which has received the image data can identify and analyze the T-code included in the image, and transfers the image to the recipient's e-mail address or the like obtained as a result. Accordingly, the recipient P does not have to input the sender address information of the sender E.

In addition, the flyer having the response written thereon is simply read by a scanner, and therefore the sender who has seen the flyer is not constrained by the IP address of hardware or the like.

In addition, when there is no available scanner, camera, or information terminal, a scanner and a transmitter may be installed in a convenience store (also referred to as an intermediate company), and used to place an order. It is needless to say that a scanner and a transmitter which are freely available may be installed in a school or a public organization.

### Embodiment 4

On the other hand, the same goes for audio media such as radio. For example, audio information is transmitted and received using radio frequency as an address. The frequency is used as address information for communicating information and therefore it is not intended to deliver the information to an “address” other than a radio receiver. Therefore, even though the radio broadcasts that the address of a website of a company is www.xxx.d.jp, the user has to input the URL by himself when attempting to access the website of the company using a communication system of the Internet.

However, information of television or radio uses frequency information as an address, but audio information is simultaneously delivered as content.

Incorporating information corresponding to the “address” information (sender address, recipient address: T-number will also do) and the transmission method into the content information mentioned in the present method, based on a certain rule according to the medium, is to incorporate, namely in the case of radio broadcasting, information corresponding to the “address” information and the transmission method into audio information with a certain format. Specifically, by simply incorporating address information of a company as audio information into radio broadcasting, based on a rule similar to information communication via an acoustic coupler which was used in the past, broadcasting the information, recording the audio information by an individual who has received the information, and further sending the individual's own address information as the sending method information (T-code), it is possible to deliver the URL or service of the company to the individual by postal mail.

The user can realize delivery of the URL of the company to the e-mail address of the user, for example, by simply recording the broadcasting with a terminal and transmitting the data to the T-center by e-mail.

(T-Button (for Audio))

A mechanism is prepared which can provide a button on the terminal for transmission to a particular T-center, record content such as radio broadcasting, and store it as an audio file, and further it is made possible to transmit the audio file to the particular T-center by pressing the T-button.

For example, while constantly recording radio broadcasting or the like for a predetermined time period, going back from the time point when an audio version of T-code is broadcasted, and further recording information such as own address by voice may lead to a purchase procedure, when an individual, while listening unintentionally to a music of a musician, wants to purchase it, if he/she goes back to a predetermined time point to record the T-code, his/her will to purchase it, address and the like together, and simply sends them to the T-center, which may subsequently analyze the transmission destination and dispatch the audio file directly to the provider center (server system) providing the music of the musician.

Specific description will be provided below, using the drawings.

### Example of Embodiment 4

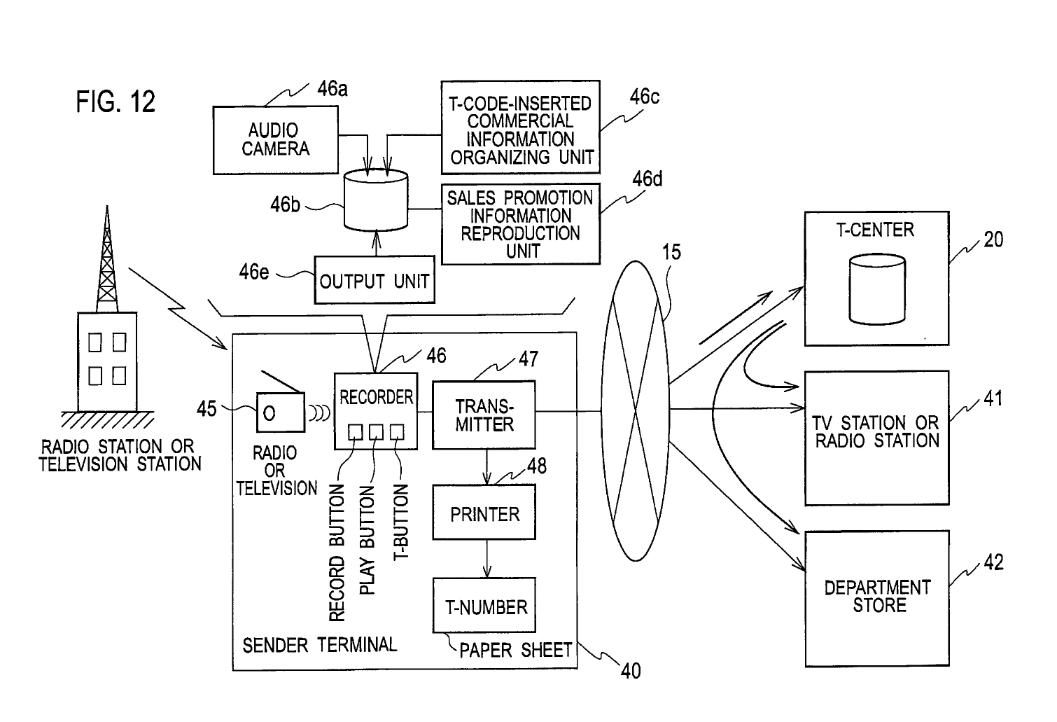

FIG. 12 is a schematic configuration diagram of an information communication system of Example of Embodiment 4. Example 4 is explained, assuming that an advertisement broadcasting from a radio station or a television station (collectively referred to as broadcast station in the following) is an advertisement of discount sale at a department store, which offers a discount of some % if pre-order is made.

In the present example, as illustrated in FIG. 12, a sender terminal 40, a server system 20 of the T-center, a server system 41 of a television or radio station, and a server system 42 of a department store are connected to the communication network 15, and the sender terminal 40 records the voice of discount sale of the department store uttered by an announcer of the broadcast station and, when the T-button is pressed, transmits the T-code of the sender and the audio information of the sender to the T-center, and subsequently transmits them to the department store.

Therefore, even if a sender listening to an advertisement of the broadcast station is inexperienced in an information device, the sender can easily send the desired item to the department store.

The sender terminal 40 described above includes a radio or television receiver 45 (will be described as a radio receiver in the present embodiment), a recorder 46, a transmitter 47, a printer 48, and the like, as illustrated in FIG. 12. In addition, the recorder 46 has a record button, a playback button, and a T-button. Furthermore, the recorder 46 has an acoustic coupler 46 or the like.

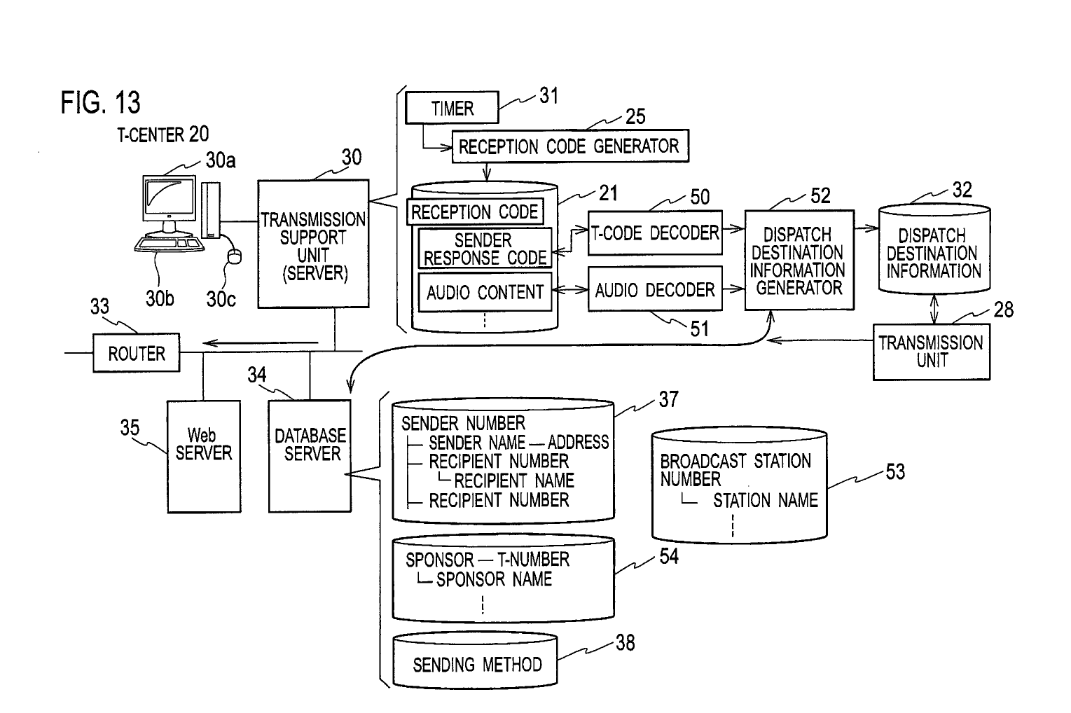

FIG. 13 is a schematic configuration diagram of a server system of the T-center. Explanation of components similar to those of FIG. 5 is omitted.

The transmission support unit (server) 30 includes the memory 21 which stores sender transmission information including a reception code, a sender response code, audio content (audio file) and the like, a T-code decoder 50 which decodes the T-code included in the audio content of the sender's voice information in the memory 21, an audio decoder 51 which analyzes the sound in the audio file of the audio content, a dispatch destination information generator 52 which generates dispatch destination information and stores it in the memory 32 from the decoding result of the T-code by the T-code decoder 50 and the decoding result of the sound decoding by the audio decoder 51, and a transmission unit 28 which sends the dispatch destination information in the memory 32 to the communication network 15.

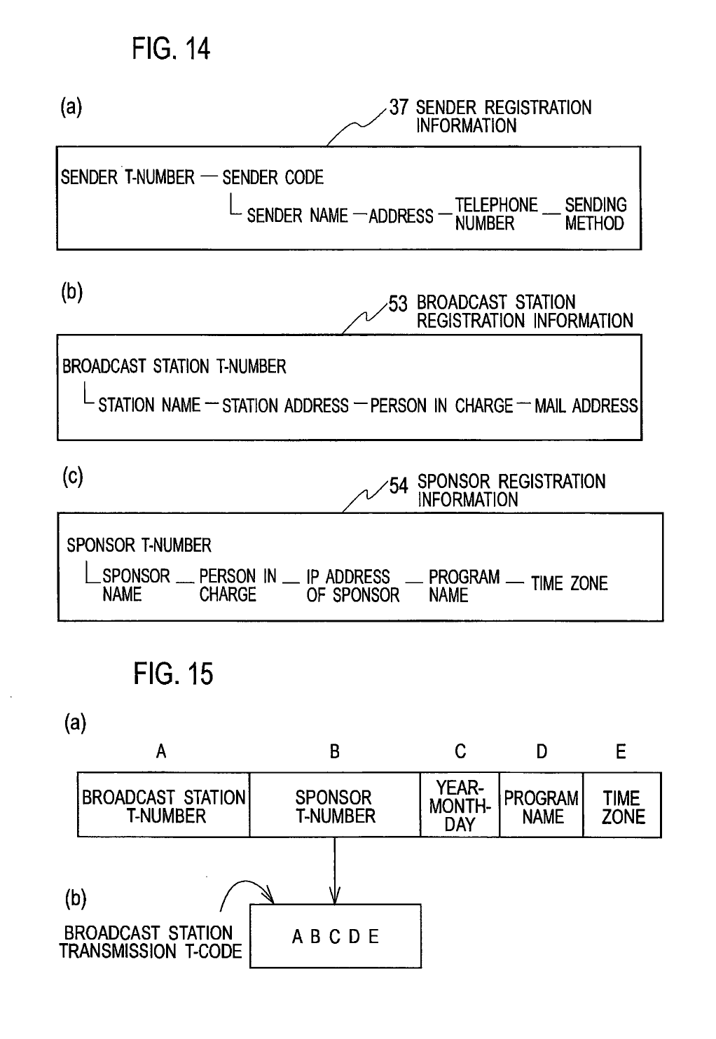

FIGS. 14(a) to 14(c) are explanatory diagrams illustrating data in various memories of the database server 34.

FIG. 14(a) illustrates sender registration information stored in the memory 37. FIG. 14(b) illustrates broadcast station registration information. The broadcast station registration information links the broadcast station T-number to station name, station IP address (URL), name of person in charge, e-mail address, FAX number, and the like.

FIG. 14(c) illustrates sponsor registration information. The sponsor information links the sponsor T-number, sponsor name, name of person in charge, sponsor IP address, program name, time zone of the program, and the like.

FIG. 15 is an explanatory diagram illustrating a broadcast station transmission T-code. The broadcast station transmission T-code is a unique code generated based on the broadcast station T-number, sponsor T-number, year-month-day, program name, time zone and the like, and the number of digits thereof is preferably 8, 10, 12, or 16.

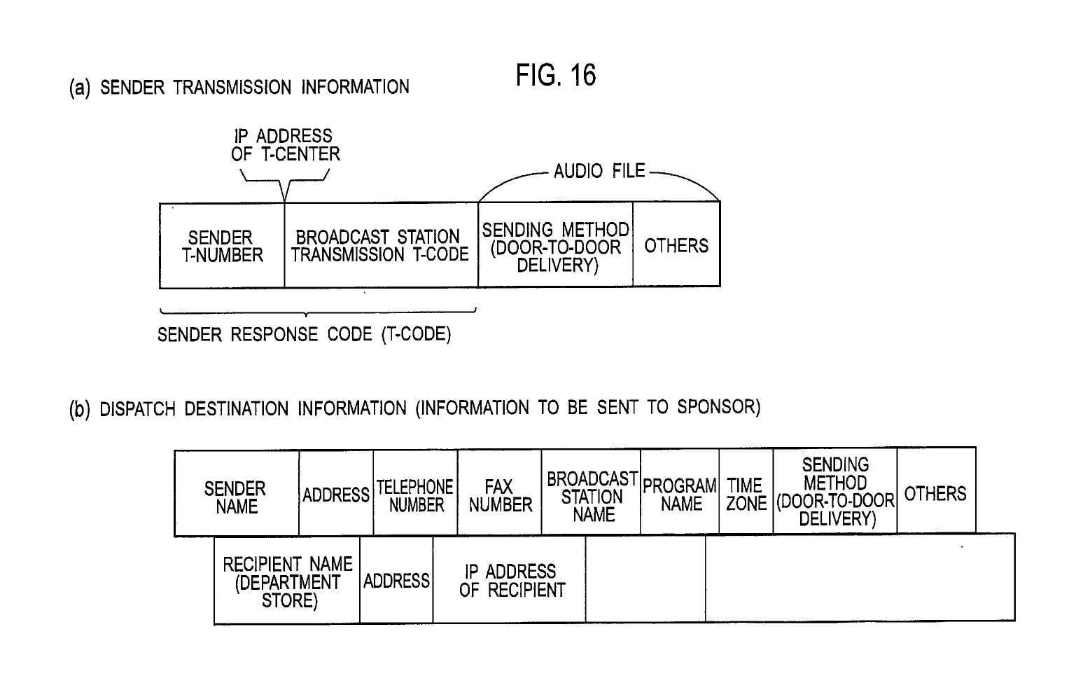

FIGS. 16(a) and 16(b) are explanatory diagrams illustrating sender transmission information from the sender terminal and dispatch destination information from the T-center, respectively.

FIG. 16(a) illustrates sender transmission information, and FIG. 16(b) illustrates dispatch information. The dispatch destination information includes the sender T-number, IP address of the T-center, broadcast station transmission T-code, sending method, and the like.

The sending method or the like of the sender information is a voice uttered by the sender, such as for example, a voice speaking “two items to be purchased and sent to me by door-to-door delivery” (audio file). As a matter of course, a preliminarily generated sound or voice may also be added.

The dispatch destination information, which is information generated by the T-center based on the destination information from the sender terminal and sent from the T-center to the department store announced at the broadcast station, includes the sender name, address, telephone number, FAX number, broadcast station name, program name, time zone, sending method (door-to-door delivery), recipient name (sender), address, and the like.

(Explanation of Each Part)

It is assumed that an announcer of the broadcast station broadcasts a sales promotion advertisement as a commercial of the sponsor during a program such as “department store XX is going to sell a product YY with a 20% discount from day d1 of month m1 to day d2 of month m2 and members of department store XX will be accepted with your T-code, so please select the T-code button (also called T-button) within 10 seconds after the bleep sound: also referred to as sales promotion information”, for example.

In addition, it is also assumed that a listener has preliminarily notified the T-center of his name, address, telephone number, FAX number and the like, as well as desired method of dispatching, to be registered in order to become a member (sender registration information: see FIG. 14(a)).

In addition, it is assumed that the broadcast station periodically broadcasts, during a program, T-code-inserted commercial information including the voice “department store XX is going to sell a product YY with a 20% discount from day d1 of month m1 to day d2 of month m2 and members of department store XX will be accepted with your T-code, so please tell a sending method and the number of items and select the T-code button (also called T-button) within 20 seconds after the bleep sound”, and a broadcast station transmission T-code (T-number of the broadcast station, T-number of the sponsor, year-month-date, program name, time zone etc.) illustrated in FIG. 15(b). The broadcast station transmission T-code included in the T-code-inserted commercial information is desired to be broadcasted as sound in a frequency band of a range which is inaudible to human ears.

On the other hand, the recorder 46 of a member listener listening to the radio extracts only the T-code-inserted commercial information using the acoustic coupler, and stores it in a memory 46b together with the year-month-day and time point.

In this occasion, a T-code-inserted commercial information organizing unit 46c does not store the extracted T-code-inserted commercial information in the memory 46b when there already exists T-code-inserted commercial information having the same broadcast station transmission T-code as the broadcast station transmission T-code included in the T-code-inserted commercial information.

In other words, T-code-inserted commercial information is repeatedly broadcasted during a program and therefore the same information which is useless is not stored. The T-code-inserted commercial information organizing unit 46c deletes the stored information if the T-code button has not been selected after a period of a day to a week elapsed (determined by time point of a timer).

In addition, if a listener is interested in the sales promotion information of the broadcast station in the course of or after completion of the program, the listener presses the playback button.

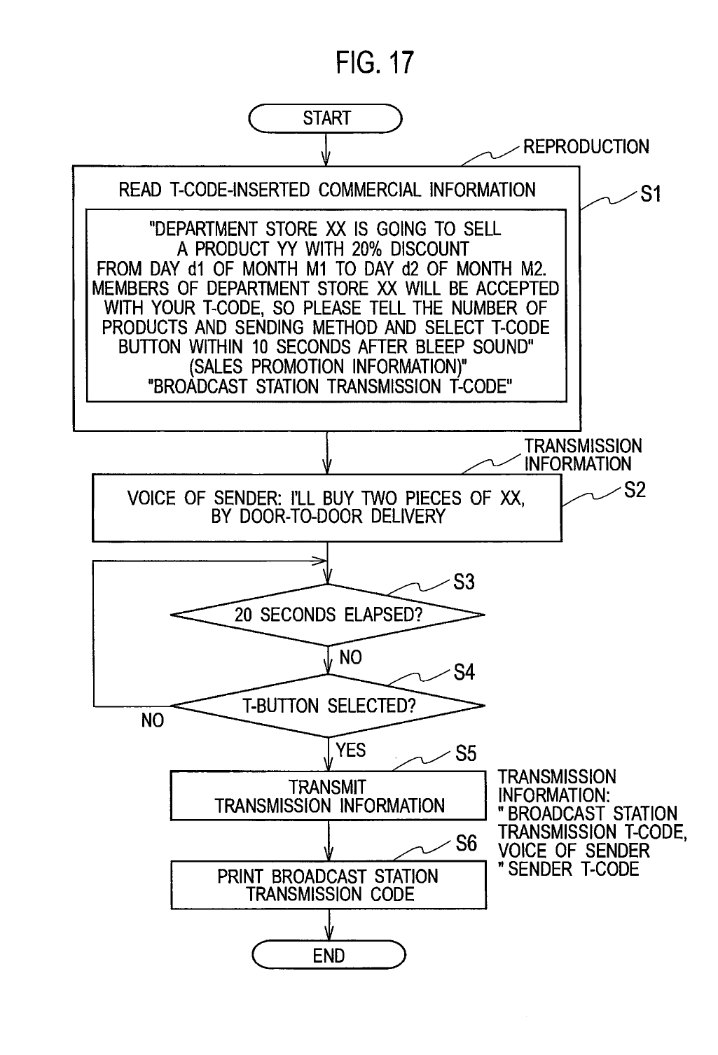

FIG. 17 is a flow chart illustrating the operation of the sender terminal caused by selecting the playback button.

An sales promotion information reproduction unit 46d, activated by pressing the playback button, reads the T-code-inserted commercial information in the memory 46b and subsequently reads and reproduces (S1) the sales promotion information included in the T-code-inserted commercial information. In this occasion, the sales promotion information reproduction unit 46d adds a reproducing flag to the end of the T-code-inserted commercial information having the reproduced sales promotion information.

Therefore, the broadcast station can select, in the course of the program, a broadcast station transmission T-code of the T-code-inserted commercial information having a reproducing flag and send it to the T-center.

Subsequently, if a listener determines to purchase an item mentioned in the sales promotion information, the listener utters “I'll buy two pieces of xx: sender's voice” (S2), for example, after the bleep sound. The voice is read by an acoustic recorder 46a and stored in a manner linked to the T-code commercial information as an audio file by the T-code-inserted commercial information organizing unit 46c.

Subsequently, it is determined whether or not 20 seconds have elapsed (S3). If it is determined at step S3 that 20 seconds have elapsed, it is determined whether or not the T-button is selected (S4). If it is determined that the T-button is selected, pressing the T-button activates an output unit 46e.

The output unit 46e searches the T-code-inserted commercial information in a memory 48b for which the reproducing flag is set ON by activation, reads the broadcast station transmission T-code and the audio file of the sender's voice included in the T-code-inserted commercial information, which are then grouped with the preliminarily registered T-number of the sender as a set (also referred to as sender transmission information) and sent to the transmitter 47 (see FIG. 16(a)).

The transmitter 47 transmits the sender transmission information (broadcast station transmission T-code, sender's audio file, sender T-code, audio file) to the T-center (S5).

In this occasion, the transmitter 47 prints out the broadcast station transmission T-code and the sender T-code from a printer 48 (S6). In this manner, the printed-out sheets may be later used for certification.

The T-center receives sender transmission information, and the transmission support unit 30 reads, upon reception, the current time point ti (year-month-day, hour, minute, second) of the timer 31, generates the reception code Ei (unique code) of several digits based on the current time point ti, and stores the reception code Ei in the memory 21 together with a broadcast station transmission code and the sender T-number.

Next, the T-code decoder 50 converts the broadcast station transmission T-code and the sender T-number into a numerical sequence and decodes it.

Decoding by the T-code decoder 50 means decoding what the broadcast station transmission T-code and the T-number indicate.

The audio decoder 51 reproduces the audio file of the sender's voice, and recognizes the number of items and the sending method.

The transmission information generator searches, in a memory, the T-code having the T-number of the broadcast station which has been decoded by the T-code decoder 50, and reads the broadcast station name, program name, and time zone included in the T-code.

In addition, the transmission information generator reads the sender name, address, and telephone number linked to the sender T-number.

Subsequently, the dispatch destination information generator 52 groups the recognized sending method (C) with the sender name, address, broadcast station name, program name, and time zone and the like as set, and transmits them to the communication network using the address of the department store.

Accordingly, the server of the department store has the aforementioned information automatically transmitted thereto, and therefore two items of the product are supposed to be delivered from the department store by door-to-door delivery based on the sending method of the sender (at a price with a 20% discount).

In addition, since the sender has printed the broadcast station transmission code, the person in charge of the door-to-door delivery can verify the identity of the recipient by checking the code printed on the printed medium and the code printed on the invoice.

There is not necessarily only a single T-address of the recipient dispatching content information, and thus it is also possible to dispatch a part or all of the content information to a plurality of addresses, or add new information to the content information and dispatch it to another specified address, by incorporating address information of route destination.

In addition, only the T-code may be separated from the content information and sent to a server which performs only a process of identifying the address and transmission method, and the information of the address and transmission method may be received and added again to the content information and dispatched to the recipient or the like.

For example, providing a function of packetizing the audio data of this example, and after the address of hardware performing communication has been identified, transmitting and receiving packets of audio data between specified addresses makes it possible to make a phone call without depending on the hardware.

In addition, leakage of credit card information in recent years may be attributed to degrading of the security level by changing the information used for authentication from handwritten signatures inherently including very original and unique information to simple digital numerals, in order to facilitate input to a terminal. In other words, it can be said that exchanging information using current information terminals experiences various limitations from terminal constraints.

If an individual intends to go as far as settlement by a credit card according to the present method, registering, at the T-center, the address information of the card company in association with the ID of the credit company, setting a T-code including information of the ID and the company providing the service, printing the T-code on catalogs or flyers and distributing them, and signing on a page thereof and transmitting it to the T-center with a scanner make it possible to distribute the image also to the card company simultaneously for settlement. In addition, preliminarily registering, by an individual, a handwritten image of the signature (information useful for personal identification without being limited to a signature) in the T-center, and sending the signature image to the company together with the image data make it possible to perform identity authentication of the individual by the company alone.

Furthermore, as described above, an ID specific to hardware such as a scanner, a camera-equipped mobile phone, or the like is preliminarily registered in a transmitter, and the information is always transmitted to the T-center separately from the image file.

Subsequently, storing the ID and the T-code of the recipient (T-number, address, sending method) in association with each other in the T-center makes it possible to search the T-code of the recipient using this ID as a key. It is also possible to use the e-mail address or the address itself as the T-number and the T-code.

(Use for Selling to Unspecified Purchasers)

Furthermore, it is also possible to perform variable print, on a newspaper flyer, a T-code (e.g., in QR code (registered trademark) form) including a unique ID as the T-number.

Furthermore, a flyer may have the location of a product handover counter printed thereon together with a message asking the purchaser to bring the flyer to receive the product. Distributing the flyer allows an individual, who has seen the flyer, to fill in (check) the order request of the product column of the flyer, scan the flyer for conversion into an image, and transmit the image to the T-center, whereby the order request is expected to reach the company which has distributed the flyer. Here, even if the individual who placed the order is unspecified, it is also possible to preliminarily deliver the product to the specified handover place by postal mail together with the T-number (the image file which has been sent thereto), perform checking of the T-code of the flyer brought by the individual with the T-code of the image which has reached together with the product, and then handover the product whose personal T-number has matched to the individual.

In other words, even if the identity of the individual is uncertain, handover of the product is possible. More specifically, assuming that information such as a unique but uncertain T-code and product ID and also the location of a bookstore near the distribution area of the advertisement as the handover place has been printed on an advertisement of a publishing company, an individual who has seen the flyer and wants to have certain books delivered may simply write an ordering message on the advertisement, scan the advertisement itself, and send it to the T-center so that the number of books ordered will be delivered to the bookstore later, and a salesclerk at the bookstore can identify and sell the desired book by simply reading the T-code of the flyer brought by the individual. This is an example of integrating a flyer distribution system using paper as media, digital media of the Internet, and a product distribution system through the use of the T-code.

Although the T-code service on a product catalog or a newspaper page, as well as a product catalog, currently requires transcription of the product number or the like to a postcard or the like purposely, actually all the company side needs to grasp which product listed on which page of the catalog, and therefore it suffices, for placing an order, that the information is incorporated in the T-code and delivered together with the image which has been marked by the individual.

Specifically, a T-code including the ID of a catalog and information of the location therein (page number) in a catalog or a newspaper are preliminarily printed on respective places. In this case there are provided a column for checking that a consumer wants to purchase, and also a column for filling in the address of the shipping destination or the T-code of dispatch destination at the side of the products on each page of the catalog, as necessary.

The individual who has seen the catalog and wants to purchase a product listed thereon checks the purchase check column of the product, scans the image including the T-code with a digital camera of a mobile phone or a scanner, and transmits it to the T-center.

the T-center can analyze the T-code sent thereto, identify the address information and dispatch method of the catalog company, and send the image thereof. The image is supposed to be an order form.

As described above, the individual does not have to handwrite the shipping destination provided that information (T-number) representing the recipient address such as the e-mail address and a number specific to the scanner has been registered in the T-center.

In addition, provided that the page number and ID of the product have been incorporated in the T-code, as information available by the company, it is possible to decode the T-code upon reaching the company and identify the product ID or page number, whereby it is possible to improve the efficiency of the task of sorting the orders at the company side.

By preliminarily inputting, in the T-code on a paper medium having provided thereon a check column for inputting response information of an individual such as questionnaires, in addition to response information collecting service, product purchase, or catalog request in a manner allowing OCR (OMR) processing thereof, an ID of the response information collecting service and an ID of the business form subject to OMR processing, and storing the business form at the T-center, it is possible to perform OMR processing of the information checked by an individual and dispatch the result thereof to a particular recipient address information (the business form ID may be unnecessary depending on the OCR software).

Applying this method for learning support also enables a service that prints a drill book having a T-code preliminarily printed thereon and, after a learner has completed learning, dispatches the drill book, as it is, to the T-center using a scanner or the like, analyzes the result, and sends the data thereof to a particular analysis center, or sends the result to a particular individual's address.

(Application to Copyright Checking)

By performing variable print of a T-code on many pages of a printed document applied to copyright checking, or inserting an ID in all the pages of an e-book (such as shading), it is also possible to generate a database for locating a particular document using a mechanism such as a robot function to transfer, to an analysis center via the T-center in a full-automatic manner, an image file which has been uploaded to the WEB. For books that need to be protected from copyright infringement, taking such a measure also makes it possible to locate a plurality of books. Since the current printing technology allows variable print to be readily performed which inserts information such as an ID different for each page, recognizing the variable print over the network and managing IDs provide deterrence, at least. Assigning an ID to each copy of books (the same goes for e-books), and reading and registering the ID at a bookstore make it possible to verify where and how a book was purchased.

In the information transmission method of the present invention, the sender terminal need not be one having an address specific to the sender.

Next, the aforementioned embodiment will be described more specifically.

This example provides a method of directly transmitting, to the assumed recipient, content which has been uploaded to the cloud.

By adding only the code (T-number) which can be linked to the combination of “how to send” including how the content is processed (process of converting an image file into printer codes, or process of simultaneously transmitting to a plurality of registered recipients) and “addresses” defined in respective communication systems, it becomes possible to specify which communication system is used and what type of process is performed on the content, and to which address the content is sent.

It becomes possible for the sender to deliver the result of a process intended for the content by only selecting a single code without being constrained by the hardware used when sending content (either by hardware without an account used for communication, or being allowed to use an account of another person).

(Transmission of Various Documents or Materials Via the Cloud)

A QR code (registered trademark) can be easily incorporated in a document generated by a word processor (pdf file) by registering the recipient T-number in the QR code (registered trademark) using fonts and a Japanese conversion function. The QR code (registered trademark) may be incorporated in an arbitrary file and the file may be sent to the T-center, where the QR code (registered trademark) can be recognized, checked, and transmitted.

As a more general method, in creation of a document with a word processor, the file can be delivered to the destination by e-mail or the like (in this case, the T-code may be a T-number of a character string instead of an image) by simply uploading the file to the T-center provided that the T-code of a destination is allowed to be recorded in the document according to a predetermined rule (e.g., property or the like).

Furthermore, it is also possible to send content from an information terminal capable of only inputting T-numbers. For example, there already exists a scanner capable of transmitting a read-in image to a predetermined e-mail address. In the case of the scanner, communication with an SMTP server of e-mail is established first, and the sender passes, directly to the server, the e-mail address of the target recipient, whereby the content is substantially sent from the SMTP server. Even the sender can deliver content to the e-mail address of the recipient only by using an e-mail system.

In other words, complicated information such as information of the IP address of the SMTP server of the sender, the IP address of the pop server of the recipient, and the e-mail address which is the account thereof cannot be delivered unless the information can be sent out at the scanner side.

In contrast, according to this example, communication systems of the sender and the recipient can be made independent of each other. In other words, even if the sender has uploaded content to a particular site using an FTP communication system, for example, the content can be delivered to the recipient by e-mail.

Specifically, provided that the scanner has only the function of FTP for uploading to the T-center, and the T-code of the recipient can be input and added as the property of the image file having read the T-code therein and uploaded to the T-center, the image file then can be attached to an e-mail and sent to the recipient according to the T-code.

Similarly, it is possible to input the T-number together with uploading an image file to a website of the T-center, and process and transmit, at the server side, a communication system which uses the T-number, the address thereof, and a conversion method or the like.

(E-Mail Usage with e-Mail and T-Number Combined)

Also with e-mail, inputting a T-number as a header and sending the text of the e-mail with the T-number added thereto as a property can automate postal mailing of printed content of the e-mail to the recipient (in a manner specified by the T-number).

The present method not only facilitates communication that links heterogeneous communication systems such as sending from e-mail to postal system, but also may lead to different usage of e-mail which uses only an e-mail system.

In other words, current e-mail systems cannot send an e-mail unless the sender preliminarily registers an account to a provider which provides e-mail service to the sender. However, provided that there can be prepared content with the T-number attached to the e-mail text according to the aforementioned method, simply sending the content with the e-mail address of the recipient always being the address of the T-center makes it possible to deliver the content which has reached the mail server of the T-center to the electronic address of the recipient corresponding to the T-number.

Although current communication systems allow delivery of content by directly linking the address of the sender and the address of the recipient, the present method is largely different therefrom in that flexible communication can be realized by inserting a transmission processing system between the sender and the recipient.

(Communication System which is Friendly to Weak or Elderly People)

Since existing communication devices have fixed addresses for respective hardware devices of the communication system, it is necessary to memorize the destination address when sending a postal mail, the telephone number when making a call, the FAX number when sending a FAX, or the e-mail address when sending an e-mail, respectively. Using the present method, for example, when an elderly person sends a letter, his/her grandchild can receive, via e-mail, the letter uploaded by the elderly person with a scanner, as long as the elderly person can memorize and input (specify) the telephone number of his/her grandchild. In other words, provided that the grandchild has registered his/her telephone number as a T-code and linked the code with his/her e-mail address, it becomes substantially possible for the elderly person to deliver a file of a letter by e-mail without knowing (remembering) the e-mail address of the grandchild but only knowing the telephone number.

(Use with Digital Camera or the Like)

For example, although it is currently possible to upload an image file or a video file captured with a digital camera to a server by FTP or the like, they cannot be transmitted to a specified e-mail address.

However, recording the T-code of the recipient in the digital camera and, when uploading the image file to the T-center, uploading the image file with the code added thereto in certain format (as file name or property information or the like) make it possible to analyze the property information at the T-center without having to analyze the photograph file itself, and transmit the image file according to the transmission method associated with the T-code (to a specified e-mail address of the recipient for example).

In addition, it is difficult with the current method to deliver a group photograph or video taken by a digital camera to each person appearing in the photograph or video. If each individual possesses a T-code (a certain e-mail address if a character string thereof has been preliminarily registered as a T-number, a QR code (registered trademark) if the T-number is carried around in the form of the QR code (registered trademark), etc.), recording the T-code in association with the photograph or video in the digital camera and transmitting it together with the image file makes it possible to transmit identical digital camera images to e-mail addresses, for example, of the people who want to receive the group photograph, as well as receiving images burned onto a CD by postal mail by specifying the transmission method of the T-code.

Specifically, in recording of photographs with a digital camera, a mechanism of adding the T-number as additional information (not inserting as an image) to the image as attribute data (property information) is prepared (in a simple example, a method of inserting an indication of being a T-code together with the T-number in the file name will do). Upon receiving the file, the T-center identifies the added T-code, searches the transmission method and address information in the database of the T-number, selects a communication system to be used for transmission, adds the address information thereof, converts the image or video data as necessary (burn the file onto a CD, for example), and sends it.

A property such as TCODE, for example, is prepared in the property information and a T-number is inserted therein, the property information is added to the image to be uploaded together, and the image data will be analyzed at the T-center according to the property.

(Method of Sending Image Data, Before Transmitting and Receiving the Image Data Between the Communication Terminal Side Such as a Scanner or Digital Camera and the T-Center, after Detecting the T-Code at the Terminal Side and Identifying the Communication Path and the Method)

If secret information, personal information, or the like is included in an image file to be uploaded from the sender to the T-code center, it may be undesirable to analyze the content thereof. In addition, a serious problem may arise in a case where an error occurs in analyzing the image which has reached the T-center and it is impossible to notify the sender of the error.

In such a case, the terminal side is made to have a function which allows preliminarily checking of the T-code to be performed with the server of the T-code center (T-center). Specifically, in the example of scanning a paper medium with a scanner, the scanner or a device to be connected to the Internet is made to have a function of preliminarily recording the URL of the T-center or the address of the server, identifying the T-code at the time point of scanning and, if there exists a T-code, connecting to the T-center, and recognizing information such as the T-code or the T-number included therein (a number or character string which can be linked to the address of the recipient and sending method: may also be linked to the sender).

The server side identifies the address of the sender and the sending method based on the received T-number and the recorded database and, if successfully identified (identification success/failure information is transmitted to a communication device on the sender side), receives the signal with a scanner, and receives image data from the scanner. The server side transmits the content data file to be transmitted to the identified communication system by the identified method.

### A More Specific Example 1

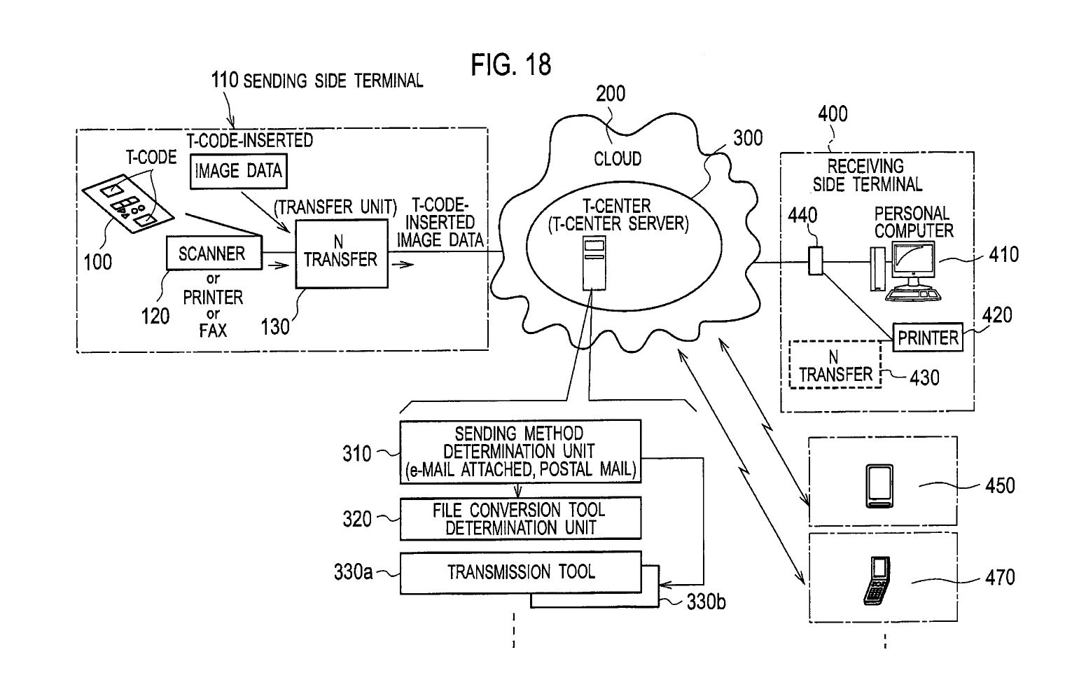

FIG. 18 is a configuration diagram of a more specific communication system (information sending method determination method according to the recipient side). The paper medium in the present embodiment may be any of a presentation material, an examination sheet, a learning material or the like for a learner given from a school, a private tutoring school or a company, but it is assumed to be a flyer in the following description.

A flyer 100 has a T-code printed thereon in the form of a 2-dimensional barcode or a 3-dimensional code.

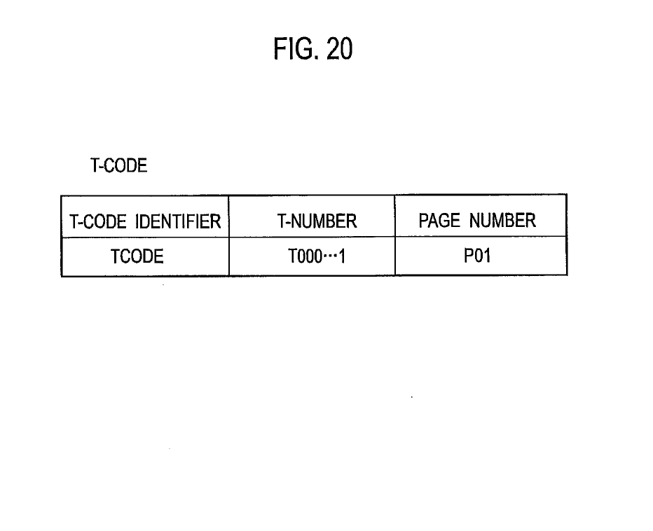

The code includes, as illustrated in FIG. 20, a T-code identifier (TCODE), a T-number, a page number, and the like. The page number is not essential.

As illustrated in FIG. 18, a sender side terminal 110 (corresponding to the sender terminal 13) includes a scanner 120 (corresponding to the scanner 10), and an N transfer 130 corresponding to the N transfer 11 (transfer unit) which transfers an image file to a server 300 of the T-center on the Internet network 200 (cloud), and the like.

The server 300 of the T-center includes at least a sending method determination unit 310, a file conversion tool unit 320 and various transmission tools 330 (330a, 330b, . . . ), and the like. The aforementioned sending method determination unit 310 and the file conversion tool determination unit 320 (also referred to as content conversion tool determination unit) correspond to the T-code decoder 26, and the transmission tool unit 330 corresponds to the transmission unit 28.

On the other hand, a recipient side terminal 400 (corresponding to 24, 23, 22) includes a recipient terminal (corresponding to the recipient terminal 24) including a router 440, a personal computer 410 and a printer 420 (with an IP address; with an Internet interface), an N transfer 430, a smartphone 450, a mobile phone 470, and the like.

It is preferred that the N transfer has the IP address of the server 300 of the T-center preliminarily stored therein. It is needless to say that an IP address of a server (not illustrated: storage server) of another information accumulation center will do.

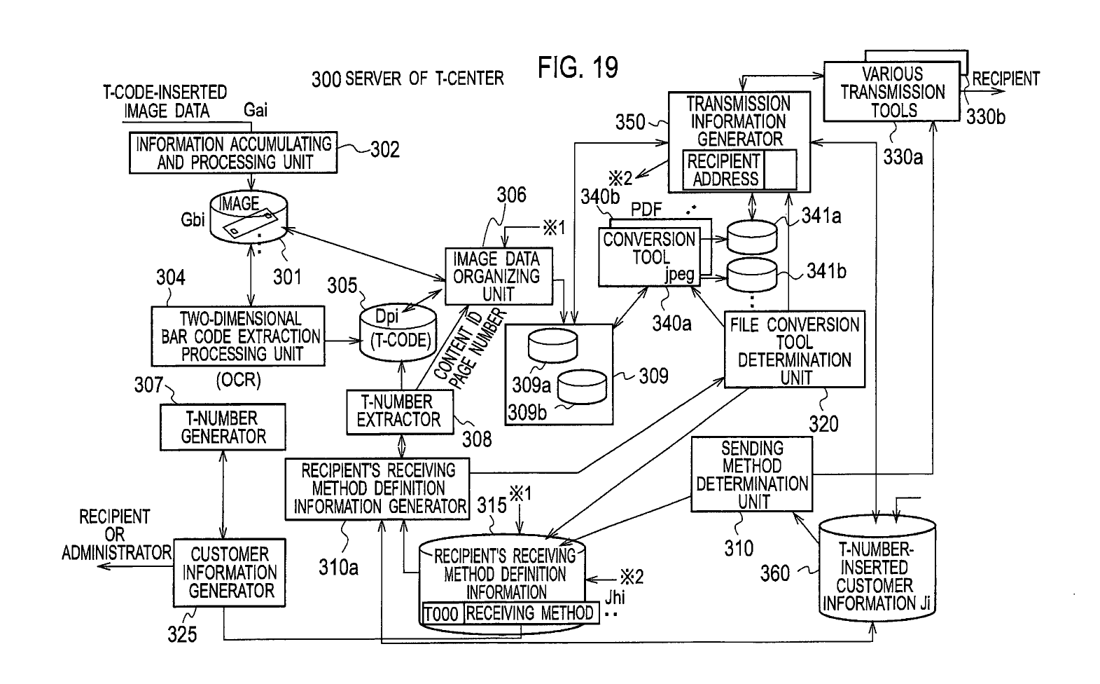

FIG. 19 is a schematic configuration diagram of the server 300 of the T-center. Although the components are based on software, the processing units may be divided for each server.

In FIG. 19, the Internet interface (Web: corresponding to the Web server 33 of FIG. 5) is omitted.

As illustrated in FIG. 19, the server 300 of the T-center includes an information accumulating and processing unit 302 which receives the T-code-inserted image data Gai (corresponding to the transmission information Ui) from the sender side terminal 100 and accumulates it in a memory 301, a 2-dimensional barcode extraction processing unit 304 which searches a 2-dimensional barcode of the T-code-inserted image data Gai stored in the memory 301 and stores, in a memory 305, data of the T-code which has been OCR-processed and converted into a numerical sequence, and the like.

The aforementioned T-code-inserted image data Gai may be transmitted from the sender side terminal 110 to a storage server (not illustrated) in the cloud and accumulated therein, and the T-code-inserted image data Gai may be received from the storage server.

In addition, the server 300 of the T-center includes a T-number generator 307 which generates a T-number (unique code: may include numerals and symbols) within 12 or 16 digits, for example, using a random number generator (not illustrated), a recipient's receiving method definition information generator 310a, and a T-number extractor 308.

The T-number extractor 308 determines whether or not the data of the 2-dimensional barcode stored in the memory 305 is a T-code and, if it is a T-code, extracts the T-number and outputs it to the recipient's receiving method definition information generator 310a.

The recipient's receiving method definition information generator 310a retrieves the T-number-inserted customer information Ji having the extracted T-number from a T-number-inserted customer information table 360 (memory), generates recipient's receiving method definition information Jhi and stores it in a memory 315. The recipient's receiving method definition information Jhi will be described in detail below.

In addition, there are also provided a customer information generator 325 which generates the T-number-inserted customer information of the T-number-inserted customer information table 360, and an image data organizing unit 306.

The image data organizing unit 306 reads the content name (image file name; content ID) of the recipient's receiving method definition information Jhi of the extracted T-number, the sender name (sender code), and the recipient name (recipient code), generates folder names with ID codes (ID codes for respective files) which can identify them, generates memory areas 309a, . . . of the folder names, and stores them in the memory unit 309. In this occasion, it is preferable to extract page numbers by OCR processing and store the folder names in a manner sorted in the order of page numbers.

The aforementioned T-number-inserted customer information Ji will be described in detail below.

Furthermore, there are provided a sending method determination unit 310 (receiving method determination), a file conversion tool determination unit 320, file conversion tool units 340 (JPEG conversion tool 340a, PDF conversion tool 340b, text conversion tool 340c, word conversion tool 340d, GIF conversion tool 340d, . . . ), memories 341 (341a, 341b, . . . ) which store the conversion data, a transmission information generator 350, and various transmission tool units 330 (mailer 330a, FAX server software 330b, printer server software 330c (printer language conversion tool (also referred to as printer control code conversion tool)), . . . , WEB server software), and the like.

When the recipient's receiving method definition information generator 310a generates the recipient's receiving method definition information Jhi in the memory 315, the sending method determination unit 310 (receiving method determination) reads the recipient's receiving method, activates a transmission tool which allows reception according to the receiving method, and causes the transmission tool to transmit the recipient's receiving method. For example, the sending method determination unit 310 activates the mailer 330a when the receiving method is via e-mail attachment, activates the FAX server 330b in the case of FAX, activates the printer server 330c in the case of printer output, and activates a WEB server in the case of a method of accessing the T-center to receive data. In the case of the WEB server, the URL is notified.

When the sending method determination unit 310 generates the recipient's receiving method definition information Jhi in the memory 315, the file conversion tool determination unit 320 activates a conversion tool (JPEG conversion tool 340a, PDF conversion tool 340b, text conversion tool 340c, word conversion tool 340d, GIF conversion tool 340d) which performs conversion according to the file processing method (image conversion format, recipient side device type, version) of the recipient's receiving method definition information Jhi.

The transmission information generator 350 generates a message to the recipient with the activated transmission tool. For example, in the case of accessing the T-center (it need not be the T-center, and may be a server of another company, school, hospital, store, or the like) to obtain data from the sender side, the transmission information generator 350 generates a message such as, for example, “There is data at the T-center from a sender xx. Please access the following URL.” and causes the transmission tool to transmit the message.

In addition, when the sending method of recipient's receiving method definition information Jhi indicates e-mail attachment, the transmission information generator 350 sends, to the mailer, the sender e-mail address and the recipient e-mail address in the recipient's receiving method definition information Jhi, for example, generates a message such as “You have data from sender Mr. XX. Please open the attached file”, for example, and causes the mailer to transmit the message.

In addition, when the sending method in the recipient's receiving method definition information Jhi indicates delivery by postal mail (door-to-door delivery), the transmission information generator 350 reads the IP address of the server in the recipient's receiving method definition information Jhi, passes data in the memory 309 to a transmission tool communicating with the server and causes the transmission tool to transmit the data.

Furthermore, when the sending method in the recipient's receiving method definition information Jhi indicates printer output, the transmission information generator 350 reads the IP address of the printer in the recipient's receiving method definition information Jhi, passes data in the memory 309 to a transmission tool communicating with the printer and causes the transmission tool to directly print the data.

Various transmission tools are provided for each device type such as PC, smartphone, mobile phone, tablet, printer or the like, with variable screen size.

(Explanation of Operation)

Important data will be described first.

FIG. 20 is an explanatory diagram illustrating data of a T-code. The T-code includes a T-code identifier (TECODE), a T-number (T000 . . . 1), a page number and the like. However, the page number is not essential.

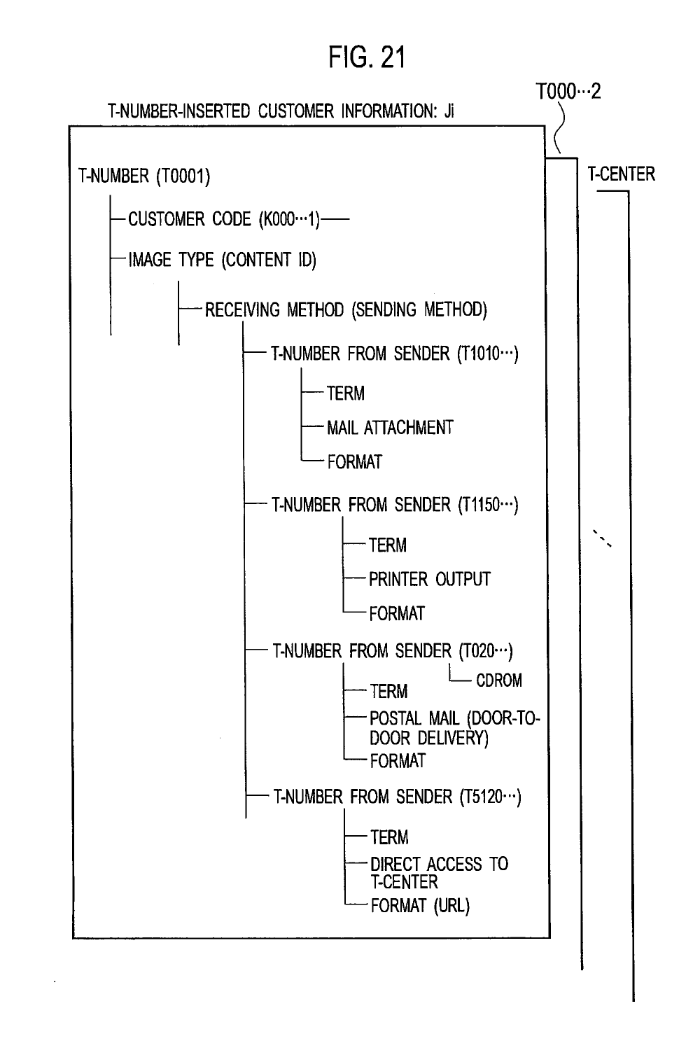

The T-number-inserted customer information Ji has a T-number (T000 . . . 1), a customer code (K00 . . . 1) of the T-number, an image type (content ID), a receiving method (sending method from the T-center) and the like linked (associated) thereto, as illustrated in FIG. 21.

The receiving method has a different T-number (T1010 . . . ) linked thereto. This T-number has linked thereto a period (period of use), a code indicating the receiving method (code indicating e-mail attachment, postal mail, or printer output), an image format, and a device type.

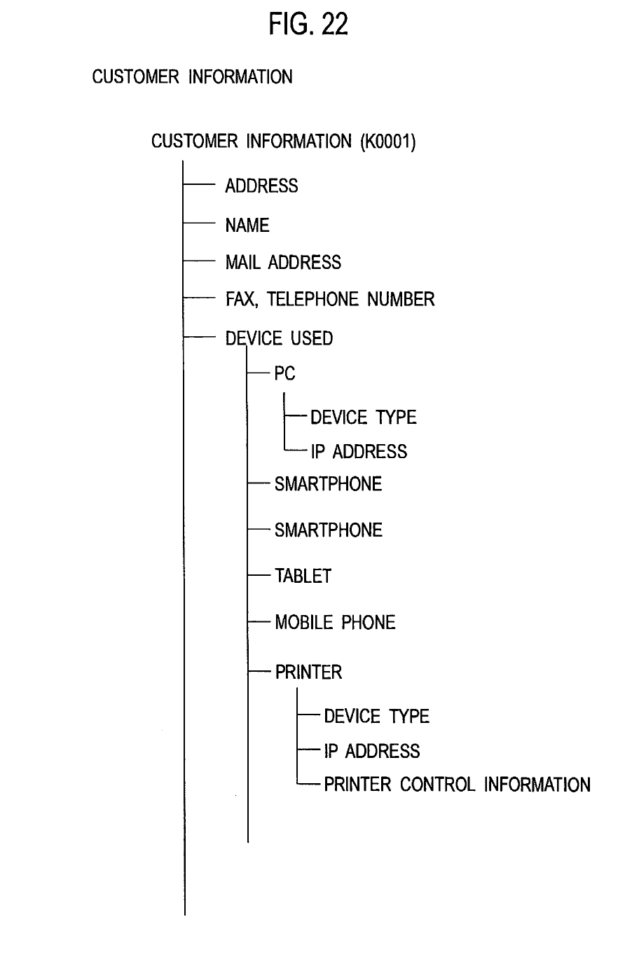

Furthermore, the customer code has an address, a name, an e-mail address, a FAX number, a telephone number, and a device used associated therewith, the device used (PC, smartphone, tablet, printer) having linked thereto a PC used, a device type thereof, an IP address thereof, and printer control information (printer control code), as illustrated in FIG. 22.

The printer control information (also referred to as printer control code) includes font, character size, two-byte character, one-byte character, English, Japanese, paper size, quality, aspect ratio, color or monochrome, and the like. It is preferred that the printer has an Internet interface with an IP address assigned thereto.

In other words, the printer server converts content (file) based on the printer control information (also referred to as printer control code).

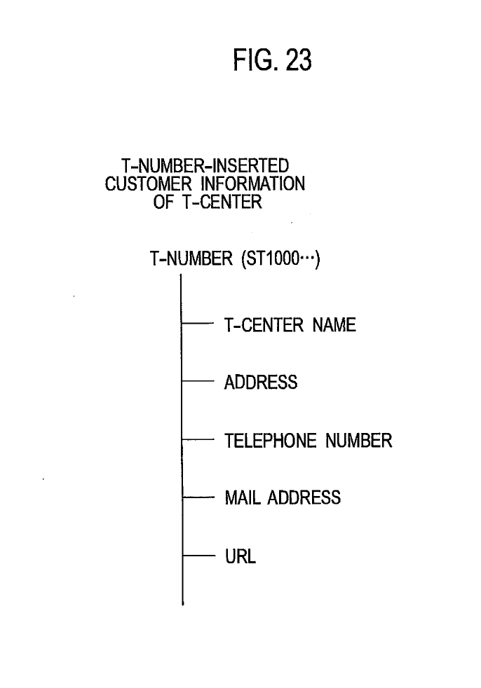

The T-number-inserted customer information of the T-center has the T-center name, address, telephone number, and e-mail address and URL of the T-center linked to the T-number, as illustrated in FIG. 23.

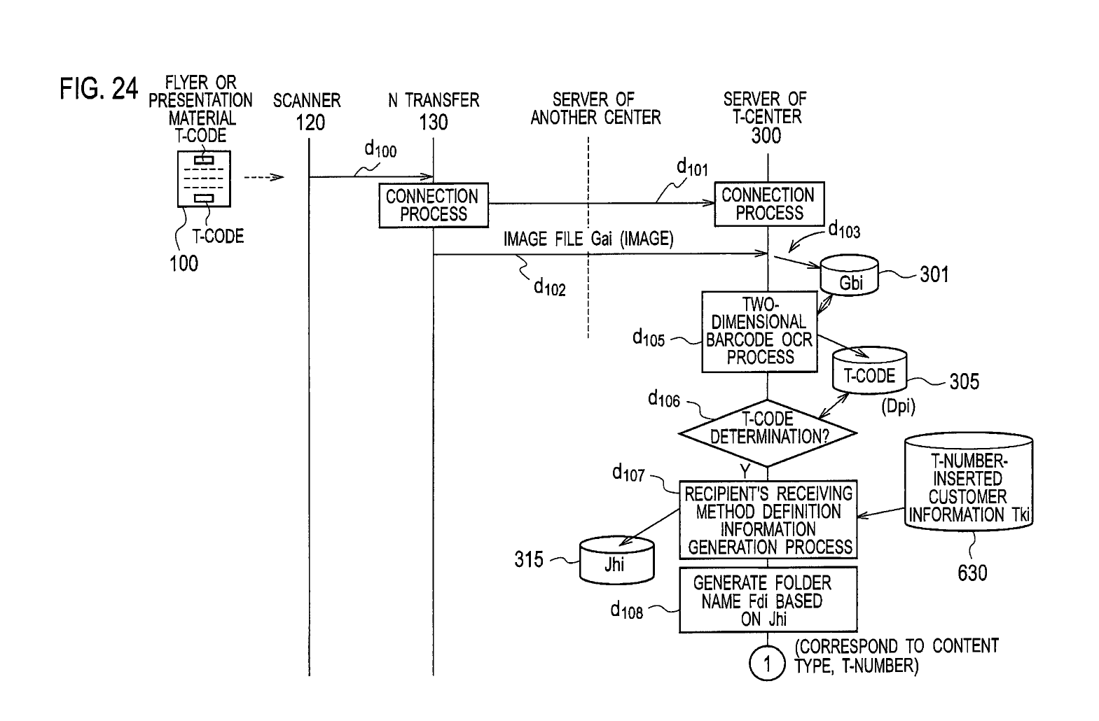

Using the foregoing, the overall operation will be described below, using the sequence diagram of FIGS. 24 to 28.

As illustrated in FIG. 24, the flyer 100 (T-code is printed in the form of a 2-dimensional barcode) is read using a scanner of the sender side terminal 110 (d100a).

The flyer 100 is read by a scanner 120 and output as T-code-inserted image data Gai to an N transfer 130 which is a cloud transfer unit (d100b).

If the IP address of the server of the T-center has been preliminarily set in the N transfer 130, a connection process is performed directly with the server 300 of the T-center (d101). If an IP address of a server of another center has been set, a connection process is performed between the server and the N transfer 130.

When the N transfer 130 is connected to the server 300 of the T-center, the N transfer 130 transmits the T-code-inserted image data Gai (d102).

The information accumulating and processing unit 302 of the server 300 of the T-center receives the T-code-inserted image data Gai and stores it in the memory 301 (d103).

Next, the 2-dimensional barcode extraction processing unit 304 performs an OCR processing on the T-code-inserted image data Gai in the memory 301 to extract a 2-dimensional barcode, decodes the numeral string, and stores it in the memory 305 (d105). The numeral string data is referred to as Dpi.

Next, the T-code number extractor 308 determines whether or not the numeral string data Dpi (symbols may be included) stored in the memory 305 is a T-code and, in the case of a T-code, extracts the T-number and outputs it to the recipient's receiving method definition information generator 310a (d106). Determination on whether the data Dpi is a T-code is performed based on whether or not there exists a T-code identifier (TCODE).

If it is determined that there exists a T-code, the recipient's receiving method definition information generator 310a generates the recipient's receiving method definition information Jhi (d107).

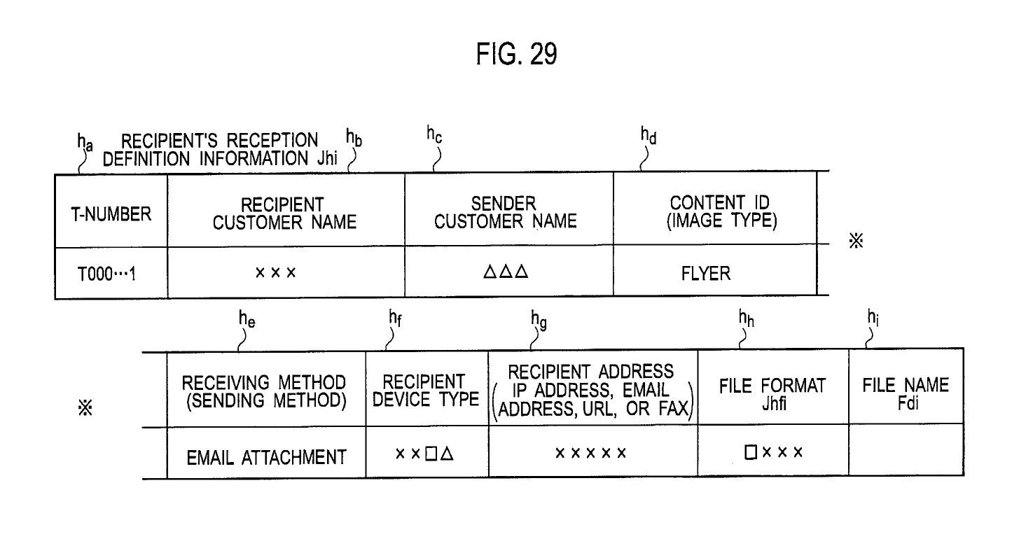

Generation of the recipient's receiving method definition information Jhi will be described. The memory 315 includes, as illustrated in FIG. 29, a T-number column ha, a recipient customer name column hb, a sender customer name column, an image type column hd, a receiving method column he, a recipient device type column hf, a recipient address column hg, a file format column Hh, a file name column hi, and the like.

The recipient's receiving method definition information generator 310a retrieves the T-number-inserted customer information Ji having the T-number (T00 . . . 1) from the customer information table 360. It is preferred that the T-number-inserted customer information Ji is preliminarily generated by the administrator.

The T-number-inserted customer information Ji is structured as illustrated in FIGS. 21 to 23.

If, for example, the T-number of the sender side is T000 . . . 1, the T-number-inserted customer information Ji illustrated in FIGS. 21 to 23 is retrieved.

Subsequently, as illustrated in FIG. 29, the recipient customer name, sender name, file type (:flyer, business form, examination question, learning question, presentation material: distinguished by content ID) indicated by the T-number (T000 . . . 1) of sender side, receiving method (sending method), recipient address, file format (PDF, JPEG, text, etc.), and the like, included in the retrieved T-number-inserted customer information Ji are written in corresponding columns of the T-number (T000 . . . 1) of the sender side. In the present embodiment, this is referred to as the recipient's receiving method definition information Jhi.

Next, the image data organizing unit 306 reads the recipient's receiving method definition information Jhi which has been generated in the memory 315, and generates a file name Fdi based on these data (d108).

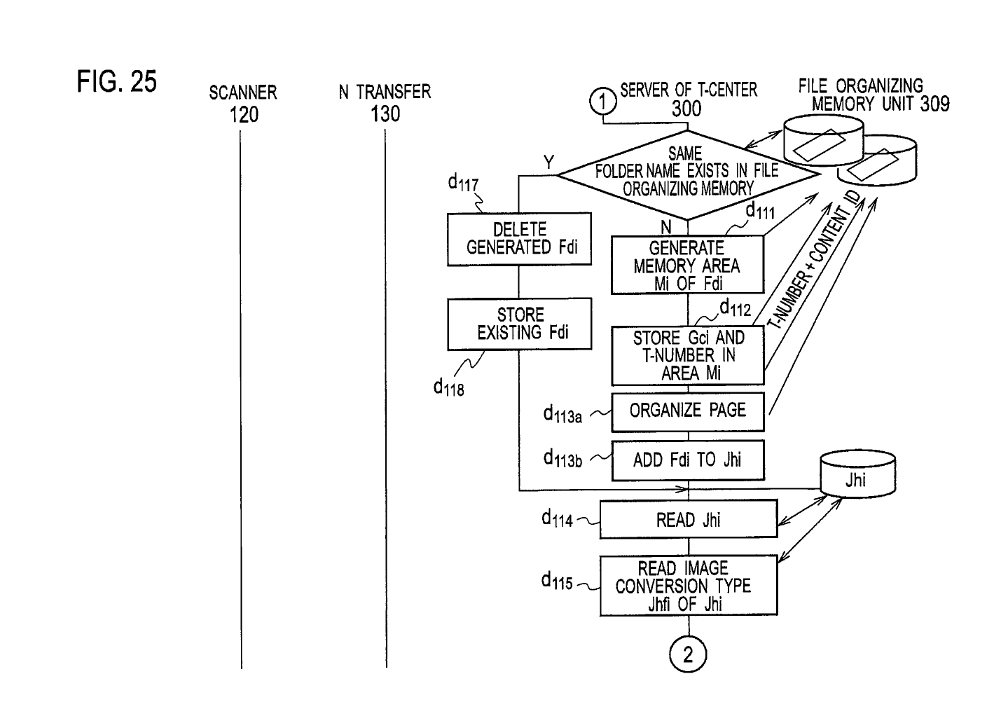

Subsequently, as illustrated in FIG. 25, the image data organizing unit 306 determines whether or not there exists the same file name as the file name Fdi generated in the file organizing memory unit 309 (d110).

If there does not exist a file with the same file name, a memory area Mi (309a or 309b, . . . ) of file name Fdi is generated in the file organizing memory unit 309 (d111). The image data organizing unit 306 then stores the T-number and the image data Gai grouped as a set in the generated memory area (d112). Next, the image data organizing unit 306 reads the page numbers (using a format determined according to the image type) of the image data Gai by OCR processing and organize them in the order of pages (d113a). Subsequently, the file name Fdi is written in the column hi (d113b).

Next, the sending method determination unit 310 reads the recipient's receiving method definition information Jhi in the memory 315 (d114).

If, in addition, it is determined at d110 that there exists the same folder name in the file organizing memory unit 309, the folder name Fdi generated at d108 is deleted (d117), and the received image data Gai and the T-number are stored (d118) in the memory area of the already existing folder name Fdi, and the process proceeds to d114.

The file conversion tool determination unit 320 reads the conversion type Jhfi of the image file in the recipient's receiving method definition information Jhi (d115).

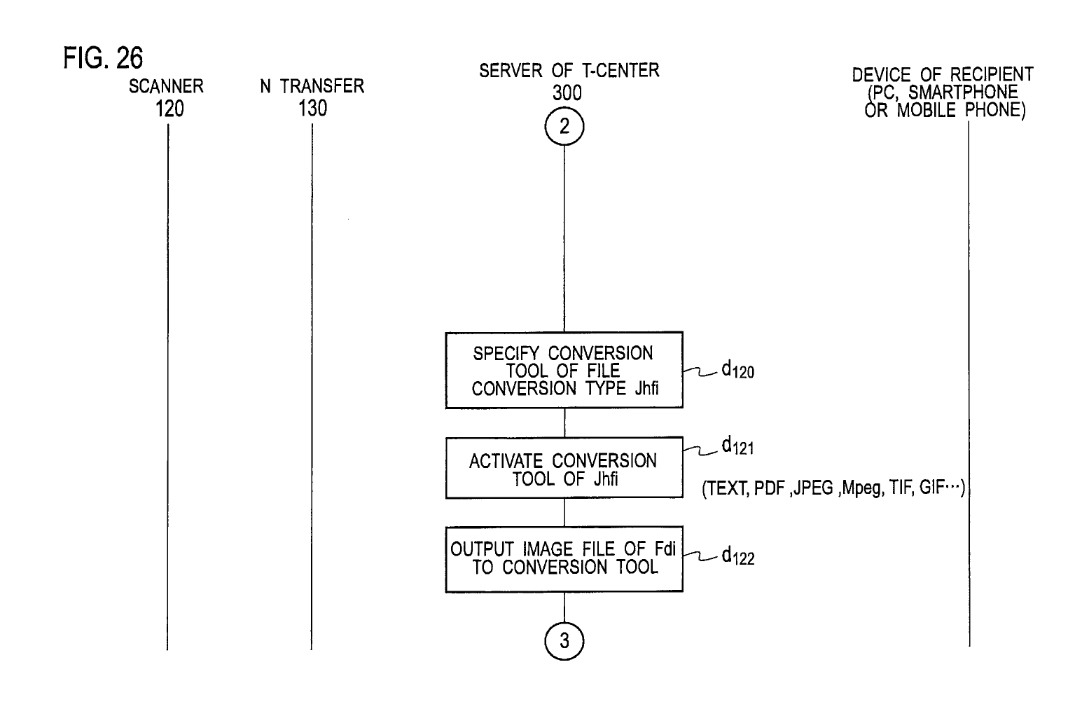

Next, as illustrated in FIG. 26, the file conversion tool determination unit 320 specifies a conversion tool (JPEG conversion tool, for example) of the file conversion type Jhfi (d120), and activates the conversion tool (d121). In other words, the recipient is supposed to have specified reception by JPEG for a sender having the T-number T000 . . . 1.

In addition, the file conversion tool determination unit 320 determines the conversion method in the recipient's receiving method definition information Jhi and the format of the received data and, for example, if the received data is text data and the conversion type of the recipient is also text, the conversion tool is not activated.

In the present embodiment, the corresponding conversion tool is activated because the received data is a flyer including a product image.

Next, the file name Fdi of the recipient's receiving method definition information Jhi is read, and the data stored in the file name Fdi is output to the specified conversion tool (d122).

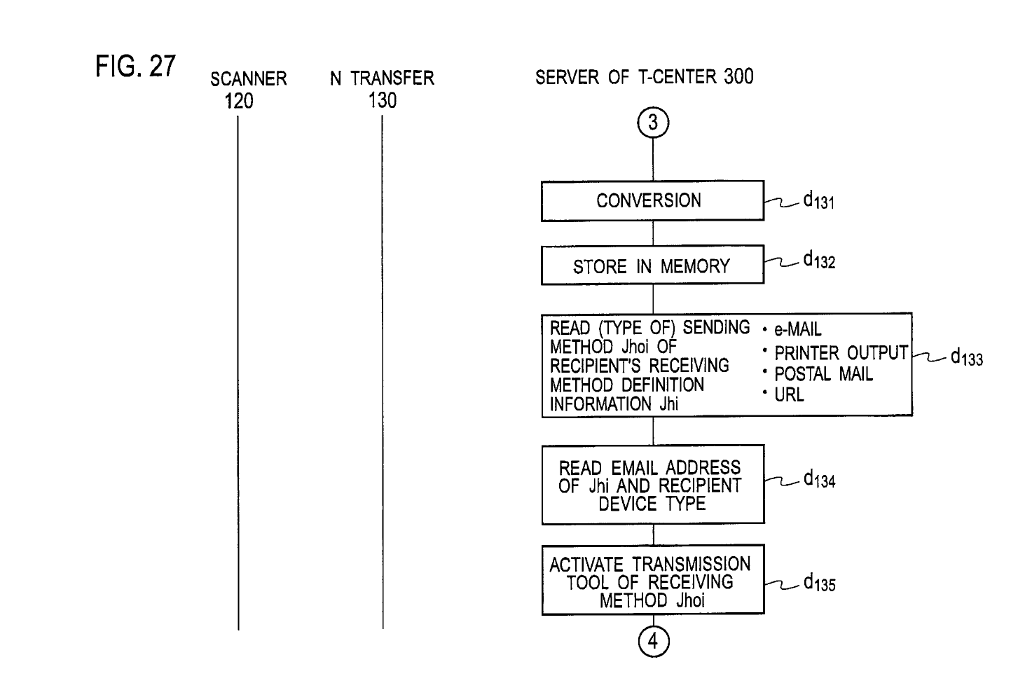

Next, as illustrated in FIG. 27, the conversion tool converts the image file which has been passed thereto (d131), and stores it in the memories 341 (341a, 341b, . . . ) (d132). These memories are provided correspond to the conversion tool.

Next, the sending method determination unit 310 reads the receiving method Jhoi (type of sending; e-mail attachment, printer output, . . . ) of the recipient's receiving method definition information Jhi (d133). For example, it is assumed that the receiving method Jhoi is e-mail attachment.

Next, the sending method determination unit 310 reads the e-mail address of the recipient in the recipient's receiving method definition information Jhi and the recipient device type stored in the memory 315 (d134). The sending method determination unit 310 then determines and activates a tool of the mailer, and also outputs the recipient device type to the tool (d135). It is preferred in the present embodiment that the e-mail address of the sender is set to be the T-center. However, the sender name is set to be the sender side.

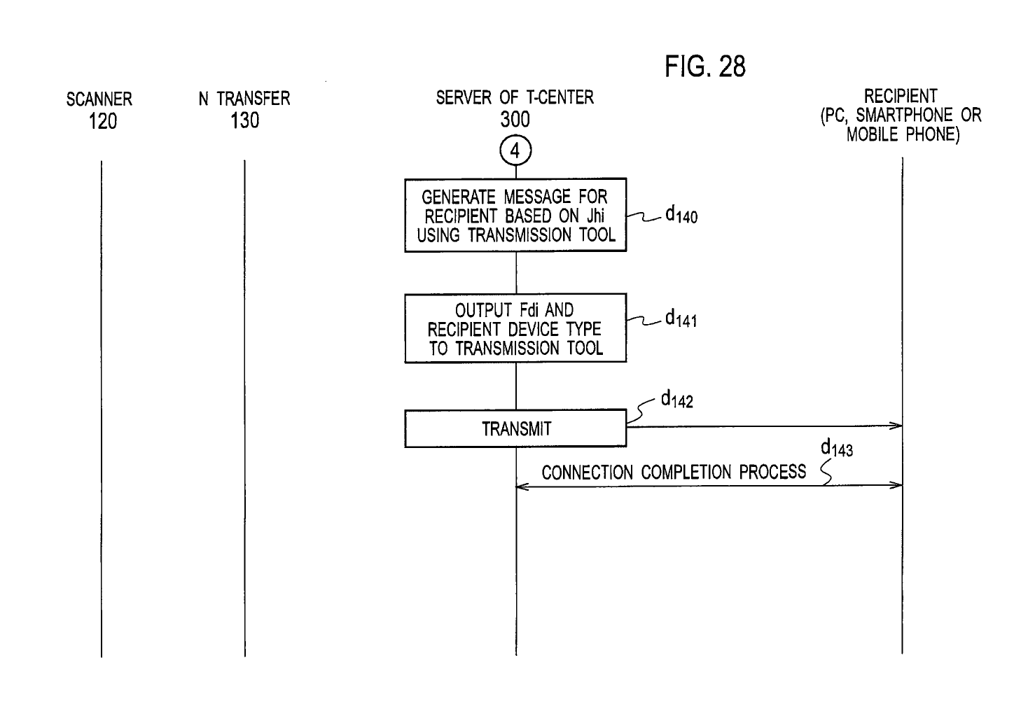

Next, as illustrated in FIG. 28, the transmission information generator 350 generates a message using the determined transmission tool (mailer in the case of e-mail attachment) (d140). For example, the transmission information generator 350 sends the sender e-mail address (T-center) and the e-mail address of the recipient in the recipient's receiving method definition information Jhi, and generates a message such as “You have data from sender Mr. XX. Please open the attached file”, for example and causes the transmission tool to transmit the message.

Next, a file in the folder Fdi of the memory unit 309 and the recipient device type are output to the transmission tool as an attachment file to the mailer (d141).

The transmission tool transmits the attachment file with the image size being changed according to the recipient device type (PC, smartphone, tablet, mobile phone, printer device type) (d142).

The transmission tool then performs the connection process with the counterpart device type (d143).

Therefore, when a recipient sees a T-code-inserted flyer and wants to purchase a product or request a catalog, the recipient may handwrite a memo such as “I want to purchase your product and my address is . . . . Please send it as soon as possible.” or “Send me a catalog.”, for example, read it with a scanner (by pressing the read button), which is then automatically transmitted to the server 300 of the T-center, so that the product will reach the recipient by the receiving method of the recipient and desired by the advertiser.

In addition, when an elderly person sends a letter or the like, attaching a T-code (unique code indicating that it is a letter from a grandfather to a grandchild A) to the letter allows the grandchild to receive the letter by e-mail which has been uploaded by the elderly person using a scanner.

### A More Specific Example 2

The present example is a method of transmitting the T-code to the server of the T-center, before the sender side terminal (scanner+N transfer or digital camera+N transfer or network digital camera) transmits image data to the server of the T-center, and sending the image data by the sender side after the server of the T-center has generated a memory area for the image data.

If secret information or personal information is included in the image file to be uploaded from the sender to the T-center, analyzing the content thereof at the T-center may be undesirable.

In addition, a serious problem may arise if an error occurs at the time of analyzing the image which has reached the T-center and the error cannot be notified to the sender. For such a case, the sender side terminal is provided with a function which allows preliminary checking of the T-code with the server of the T-code center (T-center).

Specifically, in the example of scanning the paper medium with a scanner, the scanner or the device to be connected to the Internet is provided with a function of recording the URL of the T-center or the address of the server to connect to the T-center, and recognizing information such as the T-code or the T-number included therein (numeral or character string which can be linked to the address and the sending method of the recipient: may also be linked to the sender).

The server side of the T-center then identifies the address and the sending method of the sender from the received T-number and the recorded data in the database (T-code-inserted customer information) and, when successfully identified, generates a memory area which stores the image data (image file) from the sender side in association with the T-number and, after having received the signal (transmitting identification success/failure information to the communication device of the sender side) at the sender side terminal (scanner side), the sender side terminal (scanner side) transmits the image data to the server of the T-center.

Subsequently, the server side of the T-center stores the image data transmitted thereto (also referred to as content data file) in the memory area, identifies, by the T-number of the memory area, the sending method (receiving method of the recipient side) and the image conversion method (including the image size), and transmits the image data to the recipient terminal by the sending method (e-mail attachment, printer output, postal mail (door-to-door delivery) or the like). Description will be provided below using a specific example.

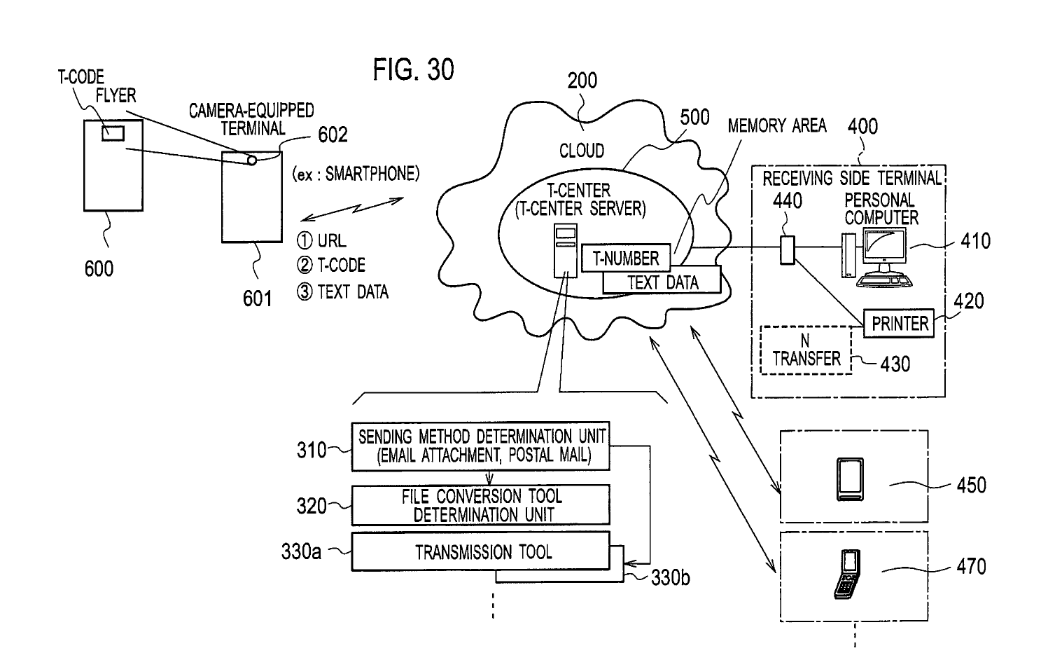

FIG. 30 is a schematic configuration diagram of a more specific Example 2. In FIG. 30, it is assumed that the sender side is a camera-equipped mobile terminal 601 (mobile phone, hand-held computer capable of audio communication (smartphone) or the like) and the T-code is printed on an advertisement 600 in the form of a 2-dimensional barcode.

On the other hand, a server 500 of the T-center includes at least the sending method determination unit 310, the file conversion tool determination unit 320, and the transmission tool units 330 (330a, 330b, . . . ). In addition, the recipient side terminal 400 is configured similarly to FIG. 18.

In other words, the camera-equipped mobile terminal 601 includes a function (unit) described below.

The camera-equipped mobile terminal 601 photographs the T-code (2-dimensional barcode) of the advertisement 600 by a digital camera 602. The T-code includes a T-code identifier (TCODE), a T-number (unique code indicating the sender, recipient, sending method, file conversion method, type of advertisement, publication date, expiration date, etc.), and the URL of the T-center, and the like.

The camera-equipped mobile terminal 601 decodes the photographed T-code using an OCR function and stores it in an internal memory.

Next, the camera-equipped mobile terminal 601 accesses the T-center according to the URL stored in the internal memory, and transmits the T-number and the T-code identifier as a set to the T-center.

Subsequently, the camera-equipped mobile terminal 601 receives a text-input page from the T-center and, upon receiving a transmission permission from the T-center, transmits the input text data to the T-center.

Anything other than a text input page will do. It is also possible to activate a sound recognition function of the camera-equipped mobile terminal and transmit the sound recognition data to the T-center.

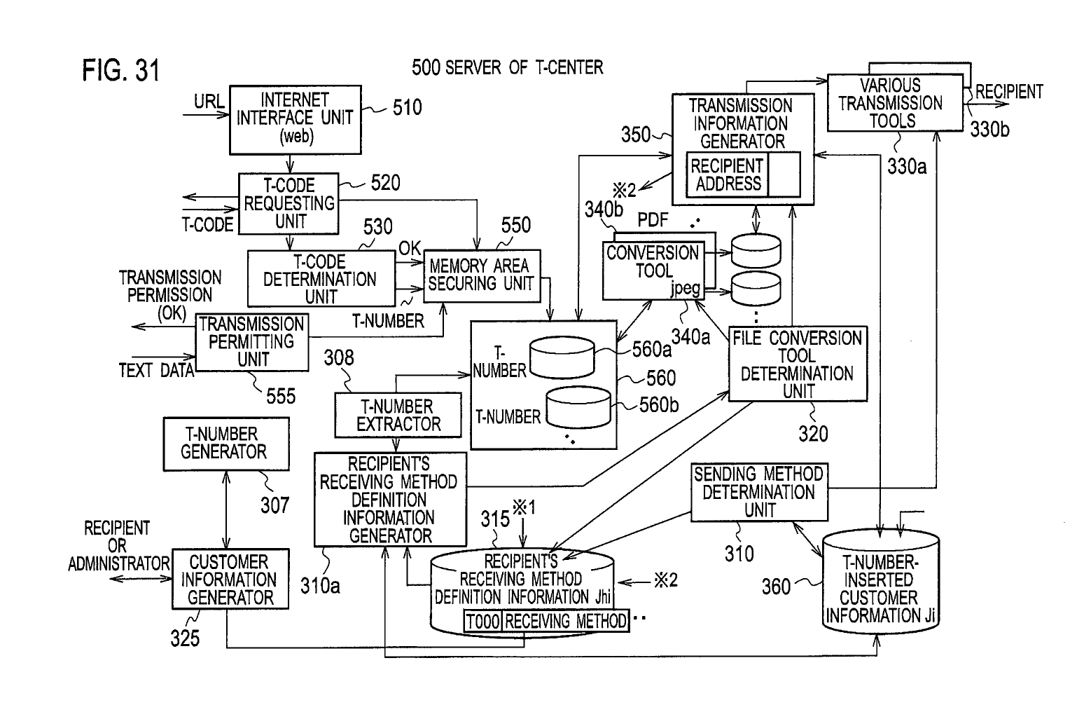

On the other hand, the server 500 of the T-center is configured as illustrated in FIG. 31. However, description of components bearing the same reference numerals as those in FIG. 19 is omitted.

As illustrated in FIG. 31, there are provided an Internet interface unit 510 (web server) which performs the Internet connection with the sender side, a T-code requesting unit 520 which, upon being notified from the Internet interface unit 510 of an access from the sender side terminal (e.g., the camera-equipped mobile terminal 601), transmits a transmission request of a T-code to the sender side terminal, a T-code determination unit 530, a memory area securing unit 550, a transmission permitting unit 555, and the like.

The T-code determination unit 530 extracts the T-number of the T-code received by the T-code requesting unit 520, determines whether or not there exists, in the memory 360, recipient's receiving method definition information Ji having the T-number and, if there exists, outputs a reception permission (OK) to the memory area securing unit 550 and outputs the T-number of the T-code received by the T-code requesting unit 520.

The memory area securing unit 550 secures a memory area of the aforementioned text input page in the memory units 560 (560a, 560b . . . ) in association with the T-number.

When the memory area securing unit 550 generates a memory area upon receiving the T-code, the transmission permitting unit 555 immediately transmits a transmission permission to the camera-equipped mobile terminal which is the sender side terminal. The address of the sender side in this occasion is obtained from the Internet interface unit 510.

The transmission permitting unit 555 then stores, in the secured memory area, the text data which have been transmitted from the sender side terminal.

(Explanation of Operation)

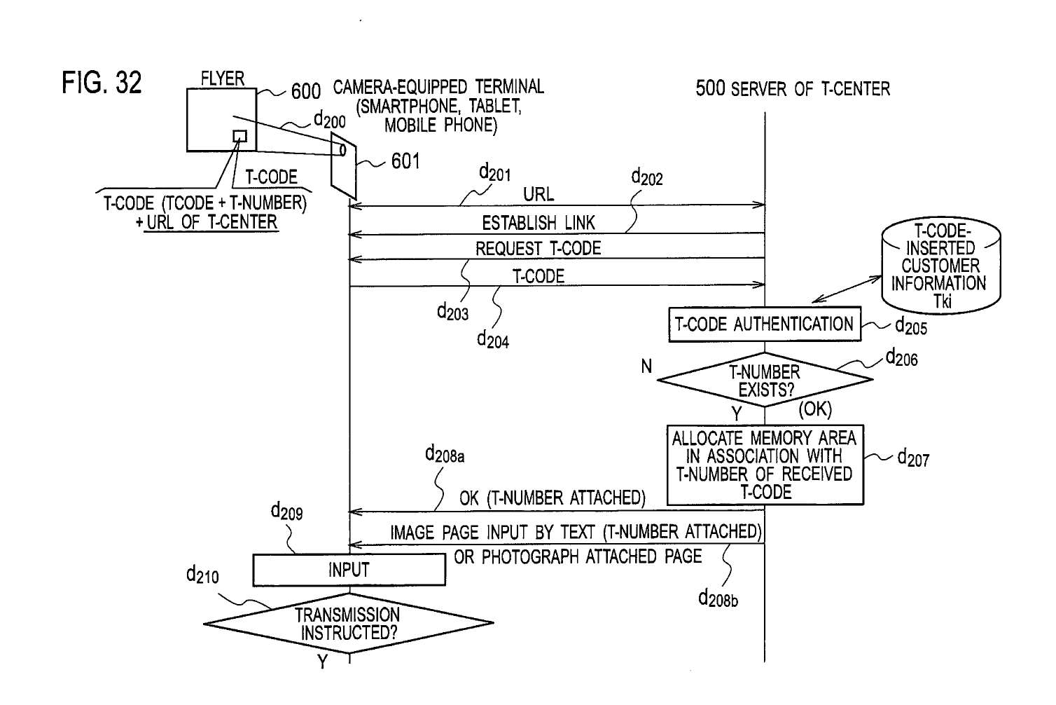

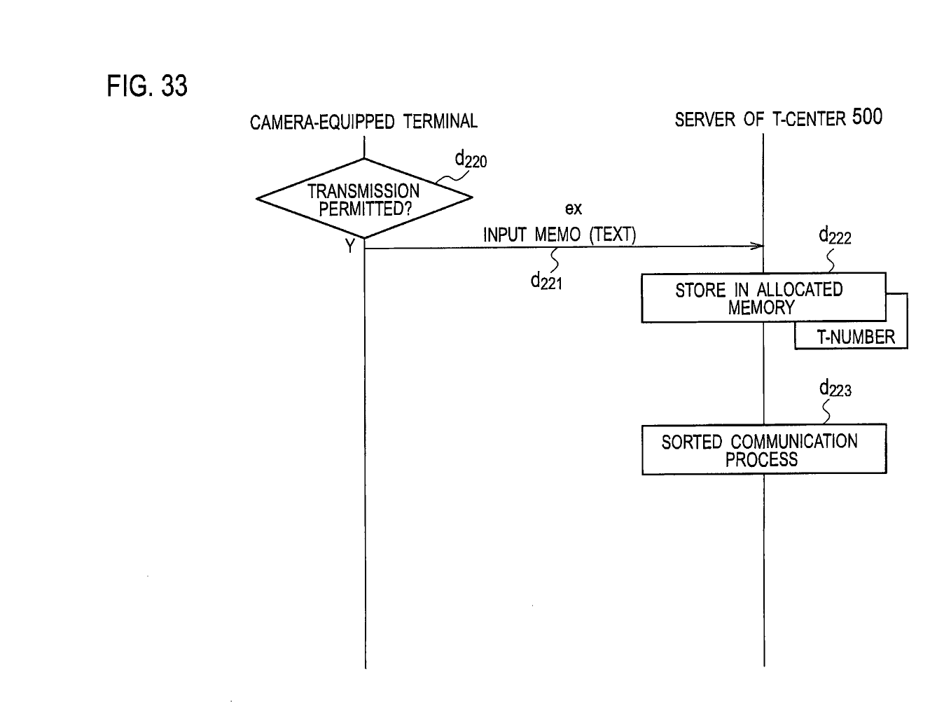

Description will be provided, using the sequence diagrams of FIGS. 32 and 33. It is preferred that the advertisement 600 is an insert flyer or a train advertisement.

As illustrated in FIG. 32, the sender side operates the camera-equipped mobile terminal 601 to photograph the T-code of the advertisement 600 (d200). The T-code is subject to OCR processing and stored in an internal memory (not illustrated).

The camera-equipped mobile terminal 601 then decodes the photographed T-code using an OCR function, extracts the URL, and accesses the T-center (d201).

The Internet interface unit 510 of the server 500 of the T-center establishes linkage with the Internet interface of the camera-equipped mobile terminal 601 (d202).

Next, the T-code requesting unit 520 of the server of the T-center requests the camera-equipped mobile terminal 601 to transmit the T-code (d203).

The camera-equipped mobile terminal 601 transmits the T-code (numerical sequence which may include symbols) which has been read according to the transmission request (d204).

On the other hand, the T-code determination unit 530 of the server 500 of the center performs an authentication process (d205, d206). The authentication process extracts the T-number of the T-code received by the T-code requesting unit 520, and determines whether or not there exists, in the memory 360, the recipient's receiving method definition information Ji having the T-number.

Subsequently, if the T-code determination unit 530 has determined that there exists the T-number (d206), the memory area securing unit 550 secures the memory area 560a in the memory 560 in association with the T-number of the received T-code (d207).

Next, the transmission permitting unit 555 of the server 500 of the T-center immediately transmits transmission permission (T-number-inserted) to the camera-equipped mobile terminal which is the sender side terminal, according to the generation of the memory area (d208a).

Subsequently, the transmission permitting unit 555 transmits an instruction of displaying the text input screen (T-number-inserted: without displaying the T-number) to the camera-equipped mobile terminal 601 (d208b).

On the other hand, the operator of the camera-equipped mobile terminal 601 inputs a comment in the displayed text input screen. For example, the operator inputs his/her address, name, e-mail address, sending method, telephone number or the like as texts (d209).

Next, it is determined whether or not the transmission button is pressed (d210). If the transmission button is pressed, the camera-equipped mobile terminal 601 transmits, as illustrated in FIG. 33, the input text data to the server of the T-center provided that the transmission permission has been received (d220) (d221). In this occasion, it is preferred that the input text data is transmitted together with the transmission permission and the T-number assigned to the text input screen.

The transmission permitting unit 555 stores the text data which have been transmitted from the sender side terminal in the secured memory area (d222).

Thereafter, the recipient side performs, as with the foregoing, a process of activating a transmission tool which determines the receiving method, converts the data into the desired image format according to the recipient device type, and transmits the information by the receiving method of the recipient (d223).

Therefore, it is expected that a catalog is delivered from the advertiser by postal mail by photographing the T-code of an advertisement attached in a train with a camera-equipped mobile terminal, writing texts such as “I want to purchase your product. My address is . . . . Please send it as soon as possible.”, “Please send me a catalog by postal mail”, for example, and transmitting it to the T-center.

### A More Specific Example 3

For example, although it is possible to take a group photograph with a camera-equipped mobile terminal and dispatch the photograph to each person, the recipient side may want to receive the group photograph by e-mail attachment, receive it in the form of a CD-ROM, receive it in form of a printed medium, or receive it by accessing a URL.

The present embodiment makes it possible to receive a group photograph by a receiving method according to each person's preference.

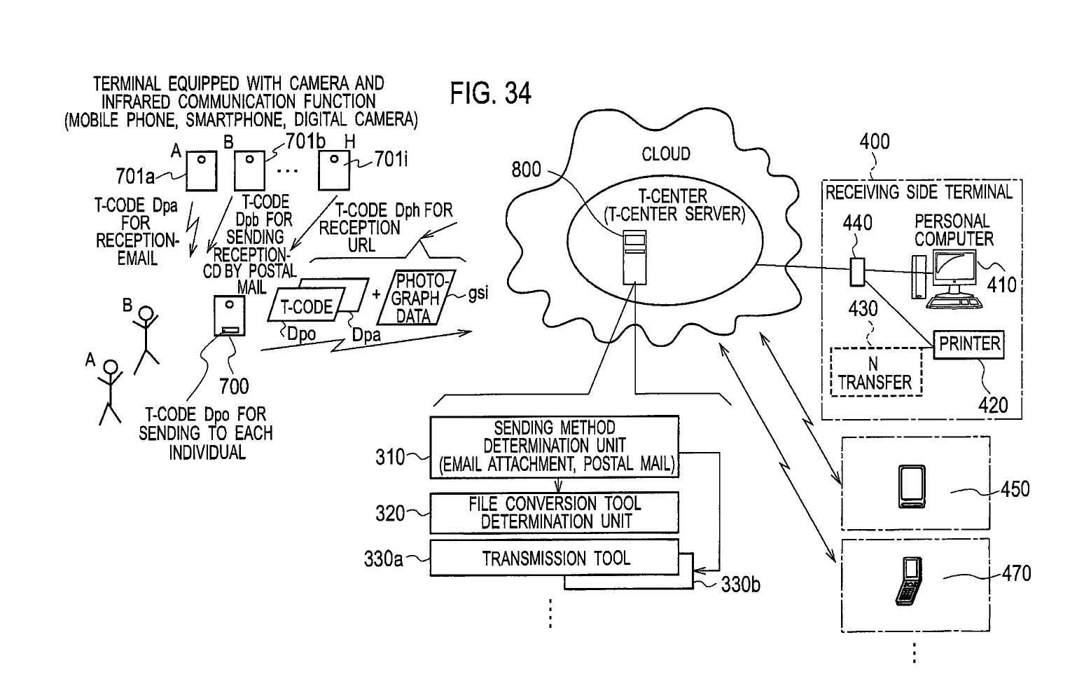

FIG. 34 is a schematic configuration diagram of a more specific Example. For example, an example of transmitting a group photograph to each member is assumed.

Additionally, in the present embodiment, information of the members and the photographer of the group photograph has already been subscribed in the T-center.

The camera-equipped mobile terminals 700, 701a, . . . are provided with a function (unit) of accessing the URL of a server 800 of the T-center, receiving input pages for a recipient and a sender, receiving several types of desired T-codes and registering them in the memory.

The input page for a recipient (not illustrated) includes, for example, a recipient customer code column of the, a recipient customer name column, a sender customer code column, a sender name column, a content type column (photograph, presentation material, . . . ), a receiving method column (e-mail attachment, postal mail of CD-ROM, T-center access, . . . ), or the like.

The recipient customer code of the sender (Mr. A, B, . . . or H), recipient customer name, sender customer code, sender name (Mr. L), content type (photograph, presentation material, . . . ), sending method (e-mail attachment, postal mail of CD-ROM or T-center access, . . . ), or the like are input in the recipient input page and transmitted to the server of the T-center, from which a desired T-code is received and registered in the memory.

For example, Mr. L's camera-equipped mobile terminal 700 of receives and stores a T-code (also referred to as T-center sender side definition T-code) indicating that a photograph (image type) is transmitted to all the members registered in the terminal from Mr. L by e-mail attachment.

The camera-equipped mobile terminals 701a, 701b, . . . , 701h of Mr. A, B, . . . H receive a T-code (also referred to as recipient side receiving method definition T-code) indicating that reception of a photograph (image type) from Mr. L by e-mail attachment.

Furthermore, an input page (not illustrated) of the sender includes a sender customer code column, a content type column, a sending methods, or the like. The sending method is such as, for example, delivery to group, all members, or selection.

In addition, each of the camera-equipped mobile terminals 700, 701a, . . . is further provided with

a function (unit) of taking a photograph, by pressing a photographing button, and storing the photograph image gsi in a memory;

a function (unit) of displaying the stored T-code and the meaning thereof on a screen displaying;

a function (unit) of reading the T-code displayed on the screen, performing infrared communication;

a function (unit) of storing the T-code which has been transmitted by infrared; and

a function (unit) of combining, by a captured image transmission instruction, each of the T-codes stored in memory (referred to as group T-code), embedding in the header, and transmitting it to the server 800 of the T-center as transmission information Gsi together with captured photograph image gsi.

In this occasion, it is preferred to place the T-code of Mr. L at the top (indicating group distribution of photographs from Mr. L) since Mr. L is the sender of content to the T-center.

FIG. 34 illustrates a case where the camera-equipped-equipped mobile terminal 701a of Mr. A has registered therein a recipient side receiving method definition T-code Dpa indicating reception by e-mail attachment, the camera-equipped mobile terminal 701b of Mr. B has registered therein a recipient side receiving method definition T-code Dpb indicating reception of a CD-ROM by postal mail, and the camera-equipped mobile terminal 701h of Mr. H has registered therein a recipient side receiving method definition T-code Dph indicating reception of a URL. In addition, there is illustrated that the camera-equipped mobile terminal 700 of Mr. L (photographer) has registered therein a T-code Dpo (T-center sender side definition T-code) indicating sending to each person.

On the other hand, the server 800 of the T-center is provided with at least the sending method determination unit 310, the image file conversion tool determination unit 320, and various conversion tools (330a, 330b, . . . ), or the like.

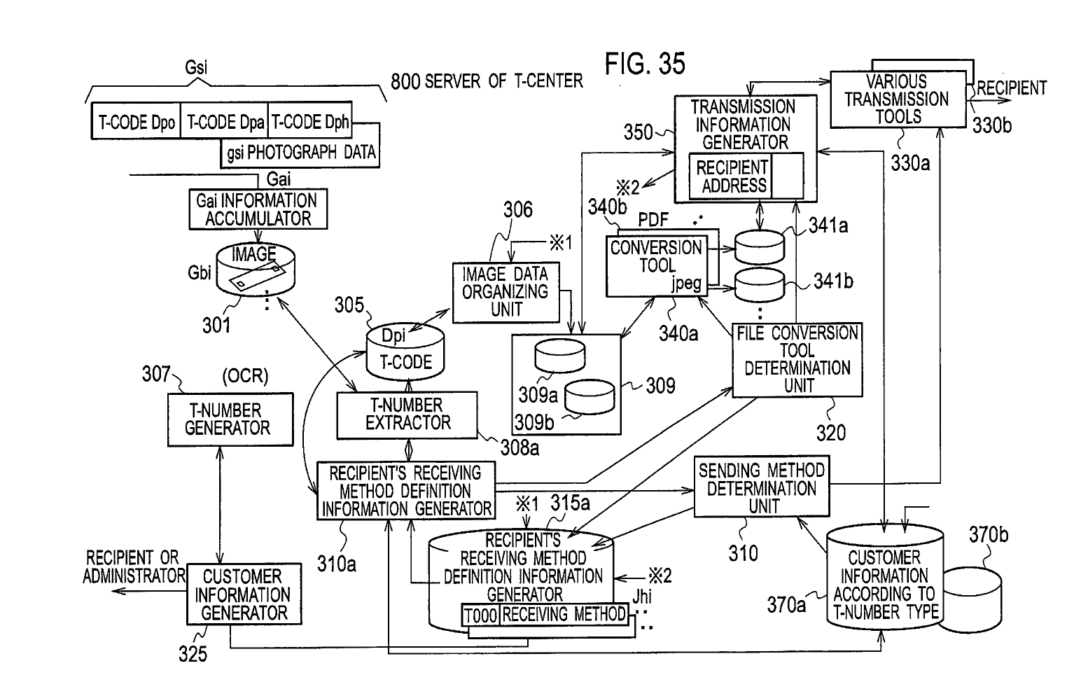

FIG. 35 is a schematic configuration diagram of the server 800 of the T-center. However, description of components having the same reference numerals as those in FIG. 19 is omitted.

There are provided a T-number extractor 308a which stores, in the memory 305 sequentially from the top in a manner delimited by T-code identifiers, group T-codes (T-center sender side definition T-code Dpo, recipient side receiving method definition T-code Dpa, recipient side receiving method definition T-code Dpb, recipient side receiving method definition T-code Dph) of the transmission information Gpi from the sender side which have been in the memory 301 by the information accumulation unit 301, and the recipient's receiving method definition information generator 310a or the like. In addition, there are also provided, other than the memory 370a storing the T-number-inserted customer information, the memory 370b storing the sending method T-number information OK

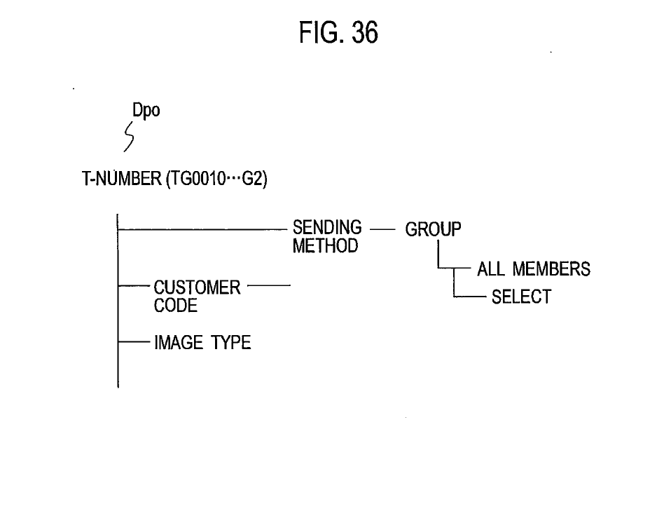

The sending method T-number information Oji has, as illustrated in FIG. 36, the sending method (group distribution, . . . ), customer code, image type, or the like linked to the T-number (TG0 . . . 1: T-center sender side definition T-code Dpo). In other words, the T-center sender side definition T-code Dpo is a unique code indicating what kind of content is group-distributed from what kind of sender.

The recipient's receiving method definition information generator 310a obtains the number of T-codes stored in the memory 305, and generates the recipient's receiving method definition information generation memory (315a, 315b, . . . ) corresponding to the number of T-codes.

Subsequently, the recipient's receiving method definition information generating memories (sender side T-code column, delivering method column, recipient customer name column, sender customer name column, image type column, recipient's receiving method column, recipient device type column, recipient address column, file format column or the like) are specified (memory address) in the order from top to bottom.

Next, the T-codes stored in the memory 305 are read in sequence, and the top T-code (T-center sender side definition T-code Dpo) is written in the T-number column of the specified recipient's receiving method definition information generation memory (315a or 315b, . . . ). Subsequently, the sending method T-number-inserted information Oji having the T-center sender definition T-code Dpo (TG000 . . . 1) is retrieved from the memory 370b.

The sending method included in the retrieved sending method T-number-inserted information Oji is read.

In the present embodiment, since the sending method linked to TG00 . . . 1 is group distribution, a code (flag) indicating group distribution is written in the sending method column. In addition, a code (flag) indicating the image type (photograph) linked to TG00 . . . 1 is written in the image type column.

In addition, the T-number-inserted customer information in the memory 370b is retrieved, using the sender customer code linked to the T-center sender definition T-code Dpo of the sending method T-number-inserted information Oji as a key, and the customer name is written in the sender name column.

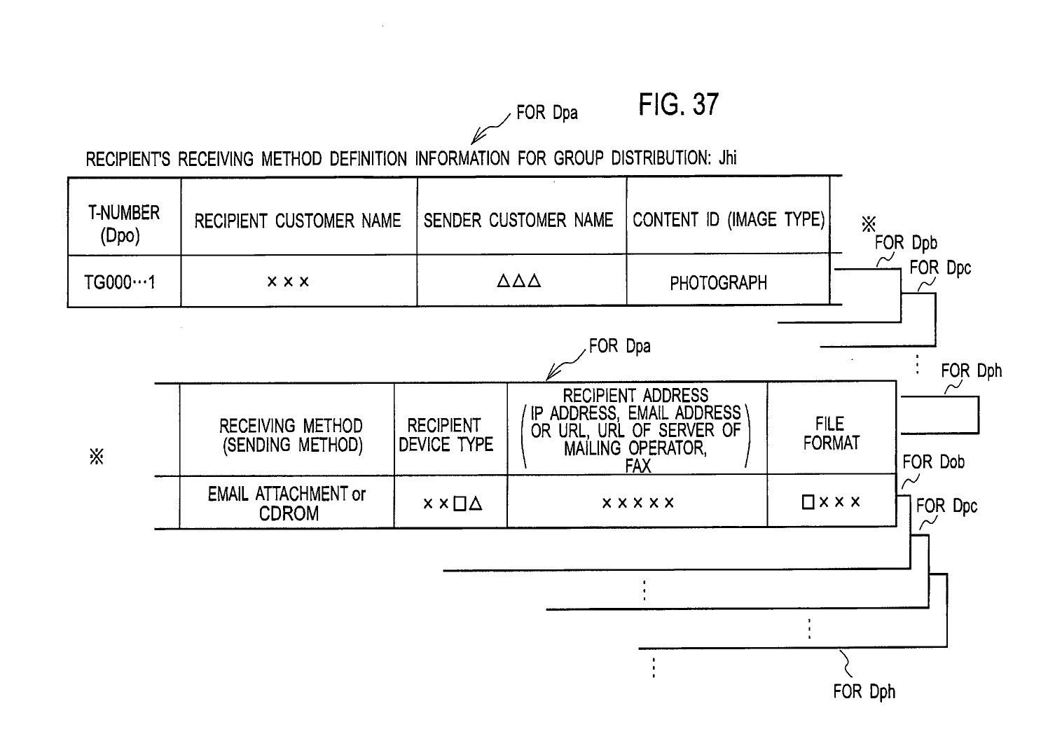

Next, the recipient's receiving method definition information generator 310a reads the next T-number stored in the memory 305, retrieves the T-number-inserted customer information having the T-number from the memory 370a, reads the customer name, recipient device type, recipient address (e-mail address in the case of e-mail attachment or, in the case of receiving a CD-ROM, IP address of the server of the door-to-door delivery provider who stores and delivers information in the CD-ROM), file format or the like, using the customer code included in the T-number-inserted customer information as a key, and writes them in corresponding columns. In other words, the recipient's receiving method definition information for the T-number Dpa is generated thereby, as illustrated in FIG. 37.

The aforementioned process is performed for subsequent T-numbers Dpb, . . . , Dph.

Thereafter, the sending method determination unit and the file conversion tool determination unit 320 sequentially call the recipient's receiving method definition information generated in the memory 315, perform process described above, and performs transmission according to the image type and receiving method specified by the recipient.

Therefore, it is expected that group photographs or the like can be received by a receiving method in accordance with the recipient.

<Exemplary Use of T-Code for Education>

Printed educational materials such as workbooks or drill books have printed (variable print: merge print) thereon, for each question or each page of the workbooks, the learner who is using them (learner ID), questions (content ID), information corresponding to a presentation repeated many times (schedule ID), the server (server ID) performing marking or recording of questions, information (TCODE) indicating that it is a T-code, and a code (this is the T-code) including an ID associated with a combination thereof, and is distributed.

A learner writes an answer on a question sheet, reads it with a scanner, and transmits the image to a predetermined T-center (any type of communication system or hardware may be used).

The T-center searches the database using the T-code as a key, recognizes various IDs, and transmits the file to the processing server of the identified ID. The processing server further identifies, by the content ID, which question the image file corresponds to, and moreover, identifies, by the learner ID, which learner the data belongs to, and, if a question appears many times, also identifies the schedule ID, and records the image data in a data recording area corresponding to the question of the learner and the schedule.

Furthermore, if it has been specified to perform processing by OCR or the like, or a correction (modification) process by a teacher, the process is performed and the resulting data is recorded in a memory area corresponding to the question. Furthermore, if it has been assumed to aggregate the data and send the result to a predetermined place, the data is sent to a specified address by a specified method.

Accordingly, a service becomes possible which allows, by simply uploading, with a scanner, the drill which has been just completed by a child at a private supplementary school, marking according to the content and sending the data of marking result to the private supplementary school by e-mail.

Here, an exemplary T-number registration screen will be described below.

(Exemplary T-Number Registration Screen)

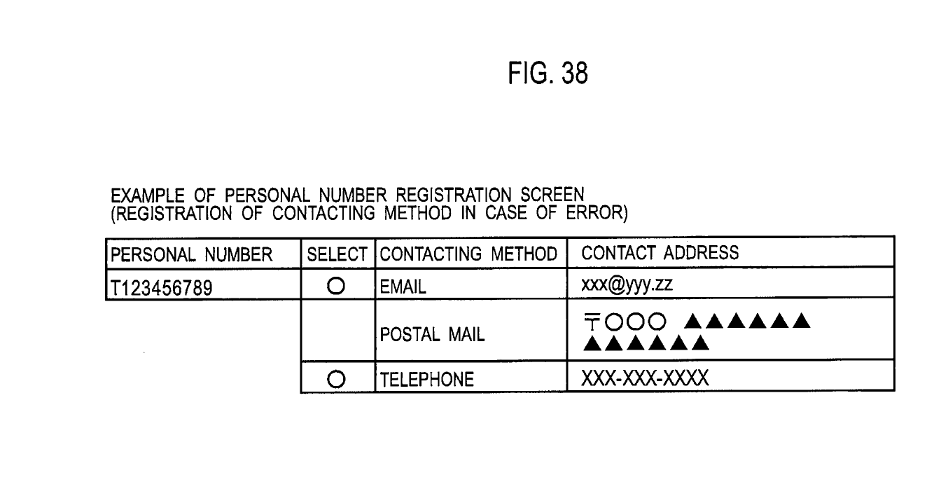

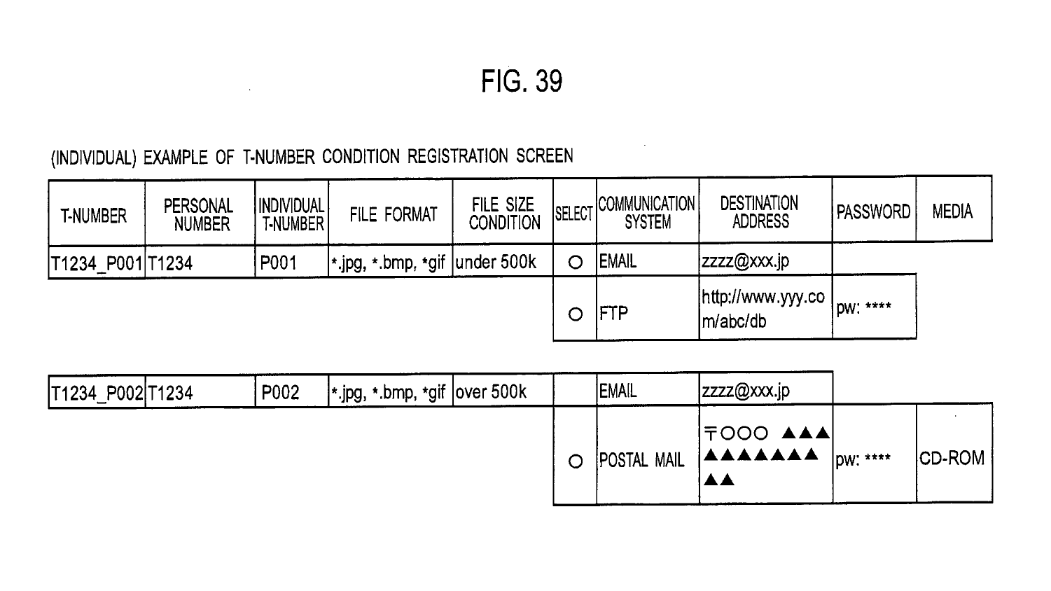

In order to perform communication using a T-code, preliminary registration of a T-number is necessary. Although registration may be performed by a staff of the T-center using the customer information generator of the server of the T-center, it is also possible to perform registration for each individual (with a personal computer or a mobile phone (including a smartphone)). Although various methods of registration are conceivable, an example is taken below in which Mr. A obtains the T-number of the recipient, with an exemplary registration screen being illustrated in FIGS. 38 and 39.

The T-center registers personal information of Mr. A and provides Mr. A with a personal number. Mr. A registers a contacting method corresponding to the provided personal number as illustrated in FIG. 38. The contacting method is for contacting from the T-center when a problem such as communication error occurs. As illustrated in FIG. 38, a personal number registration screen includes a personal number column, a contacting method selection column (e-mail, postal mail, telephone), a contacting address, or the like.

Mr. A, who has obtained his personal number, inputs the individual T-number, on the screen illustrated in FIG. 39, and also inputs a communication unit or transmission address corresponding to the number, and information or condition required for the process. The combination of individual T-numbers corresponding to a personal number is referred to as the T-number in this example. In the example of FIG. 39, although two individual T-numbers are registered, the T-code of an individual T-number P001 has transfer methods of an image file by e-mail and FTP have been registered therein, and checking both of them in the selection column specifies the content to be sent by both transfer methods. For example, deleting the check (circle) in the selection column results in a setting of distribution of all items by e-mail.

In this example, if a file with a file size of less than or equal to 500 kb has been delivered as content having a particular image file format, it is specified to transfer the file by both e-mail and FTP.

The example with the individual T-number being P002 specifies that an image with a size exceeding 500 kb is burned on a CD-ROM and sent by postal mail (with a password).

Actually, the individual who is the recipient initially registers information such as an available communication system and address or the like, and can select therefrom using a pull-down menu on the screen.

Mr. A can receive his intended content by the specified method by sending the T-number registered in such a registration screen by postal mail or as e-mail attachment to the individual (Mr. A) who has registered the seal printed on the T-code or an image, attaching the T-code on a printed medium, a photograph or a letter, or inputting the T-number at the time of transmission.

### INDUSTRIAL APPLICABILITY

According to the present invention, as has been described above, a sender who wants to provide information to the user can easily transmit information desired by the user side to the address of the destination without imposing a burden on the user, and also the user can receive the information by a method desired by the user.

1. A sender side content transmission method which receives content directed to a recipient device from a sender device, determines, by a T-number attached to the content, a receiving method determined by the recipient, and transmits the content to the recipient device using a transmission tool which allows reception in accordance with the receiving method,
the method preparing:
a first storage unit configured to store the content;
a second storage unit configured to store, as T-number-inserted customer information, a unique code defined as the T-number for identifying the recipient, the receiving method of the recipient, the form of content to be received, the type of the content and the sender of the content, the T-number being associated with customer information including the recipient name, the device type used, and the device address, a code of receiving method, a code indicating the type of content to be received, and customer information including the sender name;
a third storage unit configured to generate therein recipient's receiving method definition information for transmitting the content to the recipient device; and
various transmission tools configured to connect the recipient device to a network and perform transmission and reception in a communication format thereof, and
the method causing a computer to execute the steps of:
(A1) receiving content from the sender device and storing the content in the first storage unit;
(A2) extracting the T-number from a T-code attached to the content, and storing the T-number in the third storage unit;
(A3) searching, from the second storage unit, the T-number-inserted customer information having the extracted T-number, and determining the recipient's receiving method included in the searched T-number-inserted customer information;
(A4) searching, from the customer information of the recipient included in the searched T-number-inserted customer information, the address of the recipient device capable of receiving by the determined receiving method;
(A5) reading a recipient name from the customer information of the recipient and a sender name from the customer information of the sender included in the searched T-number-inserted customer information;
(A6) generating, in the third storage unit, a set of the recipient device address, the recipient name and the sender name in association with the T-number as the recipient's receiving method definition information; and
(A7) activating the transmission tool which allows reception by the receiving method of the recipient's receiving method definition information generated in the third storage unit, and outputting the content to the transmission tool together with the address.

2. The sender side content transmission method according to claim 1, preparing various content conversion tools, wherein the T-number-inserted customer information has incorporated therein a code indicating a format of content to be received, and
the method causing a computer to execute the steps of:
(B1) determining, in a case where the searched T-number-inserted customer information includes the code indicating the format of the content to be received, whether or not the format matches the format of the received content and, in the case of a mismatch, activating the conversion tool capable of conversion in the content format, outputting the content stored in the first storage unit to the conversion tool for conversion thereby, and outputting the converted content to the activated transmission tool; and
(B2) outputting, in the case where the determination results in a match, the received content to the activated transmission tool.

3. The sender side content transmission method according to claim 1, preparing
a memory unit configured to store the content from the sender device, and
the method causing a computer to execute the steps of:
(C1) generating, along with extraction of the T-number, a memory area for storing the content in the memory unit;
(C2) transmitting, along with generation of the memory area, an input page for storage in the memory area to the sender device;
(C3) storing, in the generated memory area, content entered in the input page from the sender device; and
(C4) causing the steps (A3), (A4), (A5), (A6) and (A7) to be performed.

4. The sender side content transmission method according to claim 1, preparing
a fourth storage unit configured to store sending method T-number information having associated the T-number with a distribution type of the content, the method performing the steps of:
(D1) determining whether or not a plurality of T-numbers is attached to the content from the sender device;
(D2) determining, in a case where the plurality of T-numbers is attached, the distribution type as group distribution; and
(D3) causing the steps (A3), (A4), (A5), (A6) and (A7) to be performed for each of the plurality of T-numbers.

5. The sender side content transmission method according to claim 1, wherein one of the transmission tools is a tool for conversion into a control code of a printer of the recipient.

6. The sender side content transmission method according to claim 1, wherein the recipient's receiving method includes a code indicating reception by e-mail attachment, a code indicating reception by postal mail or door-to-door delivery, a URL for receiving by accessing a server of a T-center, a code indicating reception by FAX, and a code indicating reception by printer output.

7. An information communication system connecting a sender side device, a recipient side device, and a server of a T-center via a communication network, the server of the T-center comprising:
a first storage unit configured to store the content;
a second storage unit configured to store, as T-number-inserted customer information, a unique code defined as a T-number for identifying the recipient, a receiving method of the recipient, a form of content to be received, a type of the content and the sender of the content, the T-number being associated with customer information including the recipient name, the device type used, the device address, a code of receiving method, a code indicating the type of content to be received, and customer information including the sender name;
a third storage unit configured to generate therein recipient's receiving method definition information for transmitting the content to the recipient device; and
various transmission tools configured to connect the recipient device to a network and perform transmission and reception in a communication format thereof, and comprising:
(D1) a unit configured to receive content from the sender device and store the content in the first storage unit,
(D2) a unit configured to extract the T-number from the T-code attached to the content and store the T-number in the third storage unit;
(D3) a unit configured to search, from the second storage unit, the T-number-inserted customer information having the extracted T-number, and determine the recipient's receiving method included in the searched T-number-inserted customer information;
(D4) a unit configured to search, from the customer information of the recipient included in the searched T-number-inserted customer information, the address of the recipient device capable of receiving by the determined receiving method;
(D5) a unit configured to read a recipient name from the customer information of the recipient, and a sender name from the customer information of the sender included in the searched T-number-inserted customer information;
(D6) a unit configured to generate, in the third storage unit, a set of the recipient device address, the recipient name and the sender name in association with the T-number as the recipient's receiving method definition information; and
(D7) a unit configured to activate the transmission tool which allows reception by the receiving method of the recipient's receiving method definition information generated in the third storage unit, and output the content to the transmission tool together with the address, and
the sender device comprising:
a paper medium having the T-code printed thereon;
a scanner configured to read the paper medium; and
a transfer unit configured to transmit, as the content, image data read by the scanner to the server of the T-center via the communication network using the Internet protocol.

8. The information communication system according to claim 7 comprising:
various content conversion tools, wherein the T-number-inserted customer information having incorporated therein a code indicating a format of content to be received;
(E1) a unit configured to determine, in a case where the searched T-number-inserted customer information includes the code indicating the format of the content to be received, whether or not the format matches the format of the received content and, in the case of a mismatch, activating the conversion tool capable of conversion in the content format, outputting the content stored in the first storage unit to the conversion tool for conversion thereby, and outputting the content to the activated transmission tool; and
(E2) a unit configured to output, in the case where the determination results in a match, the received content to the activated transmission tool.

9. The information communication system according to claim 7, wherein one of the transmission tools is a tool for conversion into a control code of a printer of the recipient.

10. The information communication system according to claim 7, wherein the content is sound for response collection by a broadcast station and response sound of a sender, and the T-code is sender identification information of the sender, and wherein
the sender device has:
a receiver configured to receive sound for response collection by the broadcast station, and generate the sound from a loud speaker;
a recorder configured to record sound from the loud speaker and reproduce the sound; and
a transmitter configured to transmit, to the server of the T-center, the sound for response collection being recorded, together with the T-code, by pressing of a T-button.

11. An information communication system connecting a sender side device, a recipient side device, and a server of a T-center via a communication network, the server of the T-center comprising:
a first storage unit configured to store the content;
a second storage unit configured to store, as T-number-inserted customer information, a unique code defined as a T-number for identifying the recipient, a receiving method of the recipient, a form of content to be received, a type of the content and the sender of the content, the T-number being associated with customer information including the recipient name, the device type used, the device address, a code of receiving method, a code indicating the type of content to be received, and customer information including the sender name;
a third storage unit configured to generate therein recipient's receiving method definition information for transmitting the content to the recipient device;
a fourth storage unit configured to store sending method T-number information having associated the T-number with a distribution type of the content; and
various transmission tools configured to connect the recipient device to a network and perform transmission and reception in a communication format thereof, and comprising:
(F1) a unit configured to receive content from the sender device and store the content in the first storage unit;
(F2) a unit configured to extract all T-numbers attached to the content, and store the T-numbers in the third storage unit;
(F3) a step of determining whether or not a plurality of T-numbers is attached to the content from the sender device;
(F4) a step of determining, in a case where the plurality of T-numbers is attached, the distribution type as group distribution, and sequentially outputting the plurality of T-numbers to the unit of (F5);
(F5) a unit configured to search, from the second storage unit, the T-number-inserted customer information having the T-number for each of the output T-numbers, and determine a recipient's receiving method included in the searched T-number-inserted customer information;
(F6) a unit configured to search, from the customer information of the recipient included in the searched T-number-inserted customer information, the address of the recipient device capable of receiving by the determined receiving method;
(F7) a unit configured to read a recipient name from the customer information of the recipient, and a sender name from the customer information of the sender included in the searched T-number-inserted customer information;
(F8) a unit configured to generate, in the third storage unit, a set of the recipient device address, the recipient name and the sender name in association with the T-number as the recipient's receiving method definition information; and
(F9) a unit configured to activate the transmission tool which allows reception by the receiving method of the recipient's receiving method definition information generated in the third storage unit, and output the content to the transmission tool together with the address, wherein
the sender device is a camera-equipped mobile terminal, and
the camera-equipped mobile terminal includes a unit configured to receive T-code data from another mobile terminal, combine the T-codes, and transmit a set of the input data and the T-codes to the server of the T-center.

12. The information communication system according to claim 11 comprising:
various content conversion tools, wherein the T-number-inserted customer information has incorporated therein a code indicating a format of content to be received;
(G1) a unit configured to determine, in a case where the searched T-number-inserted customer information includes the code indicating the format of the content to be received, whether or not the format matches the format of the received content and, in the case of a mismatch, activating the conversion tool capable of conversion in the content format, outputting the content stored in the first storage unit to the conversion tool for conversion thereby, and outputting the content to the activated transmission tool; and
(G2) a unit configured to output, in the case where the determination results in a match, the received content to the activated transmission tool.

13. The information communication system according to claim 11, wherein one of the transmission tools is a tool for conversion into a control code of a printer of the recipient.

14. The information communication system according to claim 11, wherein the content is sound for response collection by a broadcast station and response sound of a sender, and the T-code is sender identification information of the sender, and wherein
the sender device has:
a receiver configured to receive sound for response collection by the broadcast station, and generate the sound from a loud speaker;
a recorder configured to record sound from the loud speaker and reproduce the sound; and
a transmitter configured to transmit, to the server of the T-center, the sound for response collection being recorded, together with the T-code, by pressing of a T-button.

15. An information communication system connecting a sender side device, a recipient side device, and a server of a T-center via a communication network, the server of the T-center comprising:
a first storage unit configured to store the content;
a second storage unit configured to store, as T-number-inserted customer information, a unique code defined as a T-number for identifying the recipient, a receiving method of the recipient, a form of content to be received, a type of the content and the sender of the content, the T-number being associated with customer information including the recipient name, the device type used, the device address, a code of receiving method, a code indicating the type of content to be received, and customer information including the sender name;
a third storage unit configured to generate therein recipient's receiving method definition information for transmitting the content to the recipient device;
a fourth storage unit configured to store sending method T-number information having associated the T-number with a distribution type of the content; and
various transmission tools configured to connect the recipient device to a network and perform transmission and reception in a communication format thereof, and comprising:
(H1) a unit configured to receive content from the sender device and store the content in the first storage unit;
(H2) a unit configured to extract all T-numbers attached to the content, and store the T-numbers in the third storage unit;
(H3) a step of determining whether or not a plurality of T-numbers is attached to the content from the sender device;
(H4) a step of determining, in a case where the plurality of T-numbers is attached, the distribution type as group distribution, and sequentially outputting the plurality of T-numbers to the unit of (H5);
(H5) a unit configured to search, from the second storage unit, the T-number-inserted customer information having the T-number for each of the output T-numbers, and determine a recipient's receiving method included in the searched T-number-inserted customer information;
(H6) a unit configured to search, from the customer information of the recipient included in the searched T-number-inserted customer information, the address of the recipient device capable of receiving by the determined receiving method;
(H7) a unit configured to read a recipient name from the customer information of the recipient, and a sender name from the customer information of the sender included in the searched T-number-inserted customer information;
(H8) a unit configured to generate, in the third storage unit, a set of the recipient device address, the recipient name and the sender name in association with the T-number as the recipient's receiving method definition information; and
(H9) a unit configured to activate the transmission tool which allows reception by the receiving method of the recipient's receiving method definition information generated in the third storage unit, and output the content to the transmission tool together with the address, wherein
the sender device is a camera-equipped mobile terminal, and
the camera-equipped mobile terminal includes a unit configured to receive T-code data from another mobile terminal, combine the T-codes, and transmit a set of the input data and the T-codes to the server of the T-center.

16. The information communication system according to claim 15 comprising:
various content conversion tools, wherein the T-number-inserted customer information has incorporated therein a code indicating a format of content to be received;
(J1) a unit configured to determine, in a case where the searched T-number-inserted customer information includes the code indicating the format of the content to be received, whether or not the format matches the format of the received content and, in the case of a mismatch, activating the conversion tool capable of conversion in the content format, outputting the content stored in the first storage unit to the conversion tool for conversion thereby, and outputting the content to the activated transmission tool; and
(J2) a unit configured to output, in the case where the determination results in a match, the received content to the activated transmission tool.

17. The information communication system according to claim 15, wherein one of the transmission tools is a tool for conversion into a control code of a printer of the recipient.

18. The information communication system according to claim 15, wherein the content is sound for response collection by a broadcast station and response sound of a sender, and the T-code is sender identification information of the sender, and wherein
the sender device has:
a receiver configured to receive sound for response collection by the broadcast station, and generate the sound from a loud speaker;
a recorder configured to record sound from the loud speaker and reproduce the sound; and
a transmitter configured to transmit, to the server of the T-center, the sound for response collection being recorded, together with the T-code, by pressing of a T-button.
